(19) United States
(12) Patent Application Publication
(10) Pub. No.: US 2026/0170557 A1
(43) Pub. Date: Jun. 18, 2026

(54) NFT MANAGEMENT APPARATUS, CONTROL METHOD OF NFT MANAGEMENT APPARATUS, AND NON-TRANSITORY COMPUTER-READABLE STORAGE MEDIUM

(71) Applicant: NEC Corporation, Tokyo (JP)

(72) Inventors: Yasuhiko YOSHIDA, Tokyo (JP); Kazuma KUNIYOSHI, Tokyo (JP); Eiji KANEKO, Tokyo (JP); Yoshitomo WARASHINA, Tokyo (JP)

(73) Assignee: NEC Corporation, Tokyo (JP)

(21) Appl. No.: 19/404,067

(22) Filed: Dec. 1, 2025

(30) Foreign Application Priority Data
Dec. 16, 2024 (JP) 2024-219546

(51) Int. Cl. G06Q 40/04

(52) U.S. Cl. CPC G06Q 40/055

(57) ABSTRACT

An NFT management apparatus includes an acquisition means and a display control means. The acquisition means acquires an NFT (Non-Fungible Token) issued by the fact that a user has purchased a product. The display control means displays information related to the acquired NFT. The display control means may display the fact related to purchase of the product as part of a transaction history of the NFT.

### INCORPORATION BY REFERENCE

This application is based upon and claims the benefit of priority from Japanese Patent Application No. 2024-219546, filed on Dec. 16, 2024, the disclosure of which is incorporated herein in its entirety by reference.

### TECHNICAL FIELD

The present disclosure relates to an NFT management apparatus, a control method of an NFT management apparatus, and a non-transitory computer-readable storage medium.

### BACKGROUND ART

There exists technology related to digital assets.

For example, Patent Literature 1 (JP2023-038224A) describes an encrypted digital asset for a footwear product, and a method for creating or using such an encrypted digital asset.

The method for providing the digital asset of Patent Literature 1 includes a first step and a second step. The first step is a step of receiving a transaction confirmation indicating a completed transaction of a footwear product or a digital file indicating the footwear product from a first party to a second party.

The second step is a step of transmitting a cryptographic block to a distributed blockchain ledger to record a transfer of the encrypted digital asset to the second party.

In a case where a figure or an in-game character or the like is purchased, there exists a user who desires to bring the purchased character or the like into a virtual space such as a metaverse. In order to satisfy such a demand, it is conceivable to issue an NFT (Non-Fungible Token) corresponding to the figure or the like in accordance with the fact that the user has purchased a product. However, in this case, the problem arises as to how the user manages the NFT owned by the user.

It should be noted that Patent Literature 1 merely discloses a technique for generating a digital asset for a footwear product. Therefore, even in a case where the technique disclosed in Patent Literature 1 is applied, it is not possible to solve the above-described problem.

### SUMMARY

It is a main object of the present disclosure to provide an NFT management apparatus, a control method of an NFT management apparatus, and a non-transitory computer-readable storage medium that contribute to improvement of the convenience of a user who owns an NFT issued by purchase of a product.

According to a first aspect of the present disclosure, there is provided an NFT management apparatus including: an acquisition means that acquires an NFT (Non-Fungible Token) issued by a fact that a user has purchased a product; and a display control means that displays information related to the acquired NFT.

According to a second aspect of the present disclosure, there is provided a control method of an NFT management apparatus, the control method including: acquiring an NFT (Non-Fungible Token) issued by a fact that a user has purchased a product; and displaying information related to the acquired NFT.

According to a third aspect of the present disclosure, there is provided a non-transitory computer-readable storage medium storing a program causing a computer mounted on an NFT management apparatus to perform processing for: acquiring an NFT (Non-Fungible Token) issued by a fact that a user has purchased a product; and displaying information related to the acquired NFT.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an example of an operation of an example embodiment;

FIG. 3 is a diagram illustrating an example of a schematic configuration of an information processing system according to an example embodiment of the present disclosure;

FIG. 4 is a diagram illustrating an operation of the information processing system according to the example embodiment of the present disclosure;

FIG. 5 is a diagram illustrating an operation of the information processing system according to the example embodiment of the present disclosure;

FIG. 6 is a diagram illustrating an operation of the information processing system according to the example embodiment of the present disclosure;

FIG. 7 is a diagram illustrating an example of a processing configuration of an integrated management server according to the example embodiment of the present disclosure;

FIG. 8 is a diagram illustrating an example of a user management database according to the example embodiment of the present disclosure.

FIG. 9 is a diagram illustrating an example of a display of a terminal according to the example embodiment of the present disclosure;

FIG. 10 is a diagram illustrating an example of a display of the terminal according to the example embodiment of the present disclosure;

FIG. 11 is a diagram illustrating an example of a processing configuration of an NFT management server according to the example embodiment of the present disclosure;

FIG. 12 is a flowchart illustrating an example of an operation of a sales control unit according to the example embodiment of the present disclosure;

FIG. 13 is a diagram illustrating an example of a display of the terminal according to the example embodiment of the present disclosure;

FIG. 14 is a diagram illustrating an example of a display of the terminal according to the example embodiment of the present disclosure;

FIG. 15 is a diagram illustrating an example of a display of the terminal according to the example embodiment of the present disclosure;

FIG. 16 is a diagram illustrating an example of a display of the terminal according to the example embodiment of the present disclosure;

FIG. 17 is a diagram illustrating an example of a display of the terminal according to the example embodiment of the present disclosure;

FIG. 18 is a diagram illustrating an example of a display of the terminal according to the example embodiment of the present disclosure;

FIG. 19 is a diagram illustrating an example of a display of the terminal according to the example embodiment of the present disclosure;

FIG. 20 is a diagram illustrating an example of a display of the terminal according to the example embodiment of the present disclosure;

FIG. 21 is a diagram illustrating an example of a processing configuration of a metaverse server according to the example embodiment of the present disclosure;

FIG. 22 is a diagram illustrating an example of a display of the terminal according to the example embodiment of the present disclosure;

FIG. 23 is a diagram illustrating an example of a display of the terminal according to the example embodiment of the present disclosure;

FIG. 24 is a diagram illustrating an example of a display of the terminal according to the example embodiment of the present disclosure;

FIG. 25 is a diagram illustrating a metaverse space according to the example embodiment of the present disclosure;

FIG. 26 is a diagram illustrating an operation of a metaverse control unit according to the example embodiment of the present disclosure;

FIG. 27 is a diagram illustrating an example of a display of the terminal according to the example embodiment of the present disclosure;

FIG. 28 is a diagram illustrating an example of a display of the terminal according to the example embodiment of the present disclosure;

FIG. 29 is a diagram illustrating an operation of the metaverse control unit according to the example embodiment of the present disclosure;

FIG. 30 is a diagram illustrating an operation of the metaverse control unit according to the example embodiment of the present disclosure;

FIG. 31 is a diagram illustrating an operation of the metaverse control unit according to the example embodiment of the present disclosure;

FIG. 32 is a diagram illustrating an operation of the metaverse control unit according to the example embodiment of the present disclosure;

FIG. 33 is a sequence diagram illustrating an example of an operation of the information processing system according to the example embodiment of the present disclosure;

FIG. 34 is a diagram illustrating an example of a display of the terminal according to a variation of the example embodiment of the present disclosure; and

FIG. 35 is a diagram illustrating an example of a hardware configuration of the NFT management server according to the present disclosure.

### EXAMPLE EMBODIMENT

First, an outline of an example embodiment will be described. It should be noted that, in the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

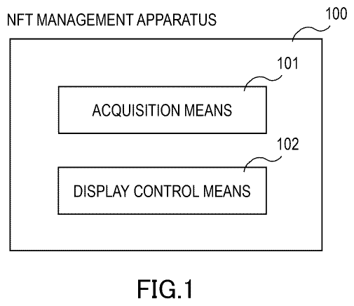

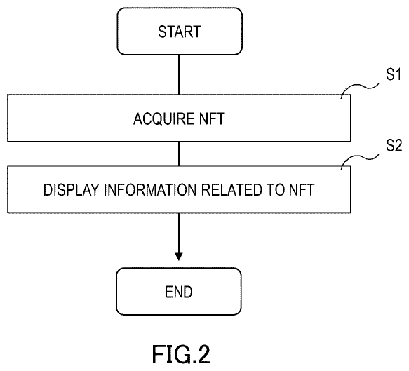

An NFT management apparatus 100 according to an example embodiment includes an acquisition means 101 and a display control means 102 (see FIG. 1). The acquisition means 101 acquires an NFT (Non-Fungible Token) issued by the fact that a user has purchased a product (step S1 of FIG. 2). The display control means 102 displays information related to the acquired NFT (step S2).

The NFT management apparatus 100 acquires an NFT issued in accordance with the fact that a user has purchased a product. The NFT management apparatus 100 displays information related to the acquired NFT. For example, the NFT management apparatus 100 displays a purchase history of a product that forms a basis of the NFT issuance as part of a transaction history of the NFT, so that it can be distinguished from a history of issuance of the NFT. Alternatively, the NFT management apparatus 100 displays a tag set for the NFT. As a result, the user can easily manage the NFT owned by the user. That is, the convenience of a user who owns an NFT issued by purchase of a product is improved.

Hereinafter, specific example embodiments will be described in more detail with reference to drawings.

### First Example Embodiment

A first example embodiment will be described in more detail with reference to drawings.

An information processing system according to the first example embodiment issues a Non-Fungible Token (NFT) for digital content corresponding to a product purchased by a user. For example, in a case where a user purchases a figure, an NFT targeting 3D data (3D model) of the figure is issued. Alternatively, in a case where a user purchases a character in a game, an NFT targeting a three-dimensional (3D) model of the character is issued.

### System Configuration

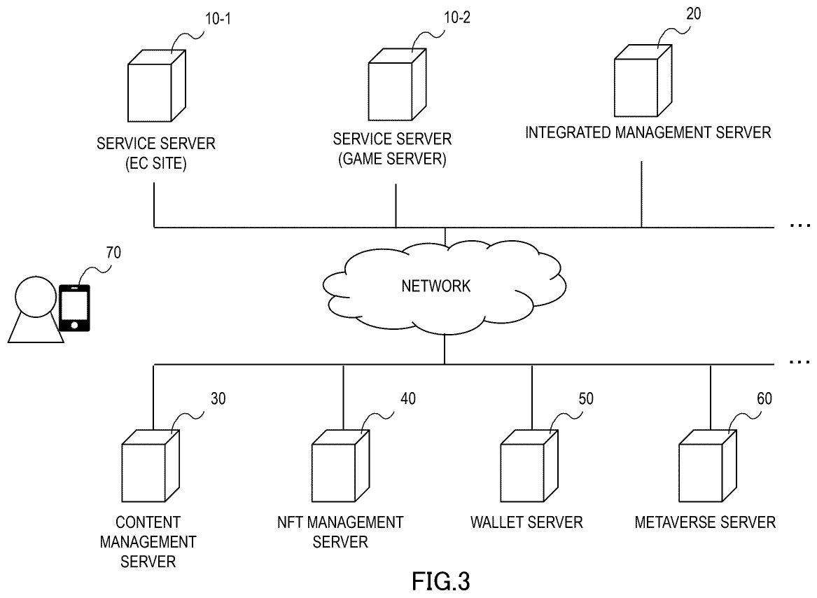

As shown in FIG. 3, the information processing system according to the first example embodiment includes a plurality of service servers 10-1 and 10-2, an integrated management server 20, a content management server 30, an NFT management server 40, a wallet server 50, and a metaverse server 60.

In the following description, in a case where there is no particular reason to distinguish between the service servers 10-1 and 10-2, they will simply be referred to as “service server 10.”

A user possesses a terminal 70 such as a smartphone or an HMD (Head Mounted Display). The user operates the terminal 70 to access various servers or the like.

The service server 10 is a server that is managed and operated by a service business operator providing various services to users.

The service server 10-1 provides an EC (Electronic Commerce) site that sells products (tangible items) such as figures (digital figures in games or virtual spaces), CDs, and DVDs, for example. Alternatively, the service server 10-1 may sell books or electronic books.

The service server 10-2 provides an online game, for example. The service server 10-2 (game server) not only controls the progress of the game but also sells to users characters (characters appearing in the game) or the like that are used in the game. The user is able to progress through the game using a character that has been purchased. That is, the service server 10-2 sells to the user the right to use a character or the like during the game.

It should be noted that, in the first example embodiment, a case in which the service server 10-2 provides a 3D game is taken as an example to describe the configuration and operation of the information processing system. However, it is not intended to limit the games targeted by the information processing system to 3D games. The games disclosed in the present application include an FPS (First Person Shooter), an action game, a fighting game, an RPG (Role Playing Game), or the like.

The integrated management server 20 is a server that is managed and operated by a business operator (platform business operator) that provides a management platform for purchased products across a plurality of service business operators (service servers 10). The integrated management server 20 provides a cross-service management service (management service related to purchased products or the like) for at least one or more service servers 10 in which the user has an account.

It should be noted that the products in the present application disclosed include not only tangible items such as figures, CDs, and DVDs, but also intangible items such as characters used in a game. That is, the products in the present application disclosed include not only tangible items in a physical space but also characters, items, or the like that exist in a 3D space. In the above example, a right to use a character or the like that appears in a game and is sold by a game server is also included as a product. In addition, a service provided by a service business operator to a user is also included as a product. Furthermore, the products in the present application disclosed are not limited to items transferred for a fee and also include items transferred without charge.

The integrated management server 20 is linked with each service server 10 through account integration. Specifically, the user is able to log into an account created for each service business operator (service server 10) via the integrated management server 20. The user purchases a product or plays a game on the service server 10 into which the user has logged in.

The integrated management server 20 is capable of acquiring a behavior history of the user on the service server 10. More specifically, the integrated management server 20 is capable of acquiring a purchase history of products, a play history of games, or the like. The integrated management server 20 generates a purchase product list of the user based on a purchase history of products purchased at an EC site, a play history of games played on a game server, or the like.

The content management server 30 is a server that performs control and management related to digital content corresponding to figures, CDs, DVDs, or the like sold to general consumers, and digital content corresponding to characters or the like sold to game users.

For example, a server that is managed and operated by an IP (Intellectual Property) holder such as a record company, a figure manufacturer, or a game manufacturer, and that performs control and management related to its own IP (intellectual property rights), corresponds to the content management server 30.

The NFT management server 40 is a server managed and operated by a business operator (an NFT platformer) that performs issuance or the like of NFTs (Non-Fungible Tokens). The NFT management server 40 issues (generates) an NFT of digital content corresponding to a product purchased by a user from a service business operator (a business operator that operates an EC site or an online game). The NFT management server 40 is an NFT management apparatus that performs management or the like of NFTs issued to a user. The NFT management server 40 includes a function as an NFT generation apparatus for generating NFTs.

In addition, the NFT management server 40 realizes a so-called marketplace. The NFT management server 40 enables buying and selling of NFT-ized digital content (digital assets) through the marketplace.

The wallet server 50 is a server that provides a wallet service related to tokens such as NFTs and SBTs (SoulBound Tokens). A user is able to prove ownership of an NFT or an SBT by opening an account (wallet) on the wallet server 50.

The metaverse server 60 is a server that provides a virtual space to users. The metaverse server 60 is a virtual space control apparatus that performs control related to a virtual space. A user accesses the metaverse server 60 using an HMD or the like and performs activities in the metaverse space provided by the metaverse server 60. The metaverse server 60 includes both a function as an NFT utilization apparatus that utilizes NFT-ized digital content and a function as a 3D model utilization apparatus.

Each apparatus shown in FIG. 3 is connected to a network. Specifically, the service server 10, the integrated management server 20, the content management server 30, the NFT management server 40, the wallet server 50, the metaverse server 60, and the terminal 70 are connected to a network via wired or wireless communication means.

The configuration of the information processing system shown in FIG. 3 is an example and is not intended to limit the configuration of the authentication system. For example, a plurality of integrated management servers 20 may be included in the system. Load distribution and redundancy may be realized by the plurality of integrated management servers 20.

### Outline of Operation

Next, a schematic operation of the information processing system according to the first example embodiment will be described.

### Account Generation

A user generates an account with each service business operator in order to purchase a figure or the like, play an online game, use the integrated management service, use the marketplace, and enjoy the wallet service.

Specifically, the user operates the terminal 70 to access the wallet server 50 and generates an account (wallet). The user operates the terminal 70 to generate an account on an EC site that handles a product the user wishes to purchase or on a game server for a game the user wishes to play. The user operates the terminal 70 to generate an account on the integrated management server 20. The user operates the terminal 70 to generate an account (an account of the marketplace) on the NFT management server 40.

### Account Integration

The user sets login information for logging into each service server 10 in the integrated management server 20. For example, the user sets login information (ID and password) for logging into an EC site, and login information for logging into a game server, in the integrated management server 20.

In addition, the user sets a wallet address (a wallet address generated by the wallet server 50) in each of the service server 10, the integrated management server 20, the NFT management server 40, and the metaverse server 60.

Each server stores the wallet address in association with the login information (ID and password) or the like of the user.

### Product Purchase

Here, a case in which a user logs into an EC site (service server 10-1) and purchases a figure is taken as an example to describe the operation or the like of the information processing system.

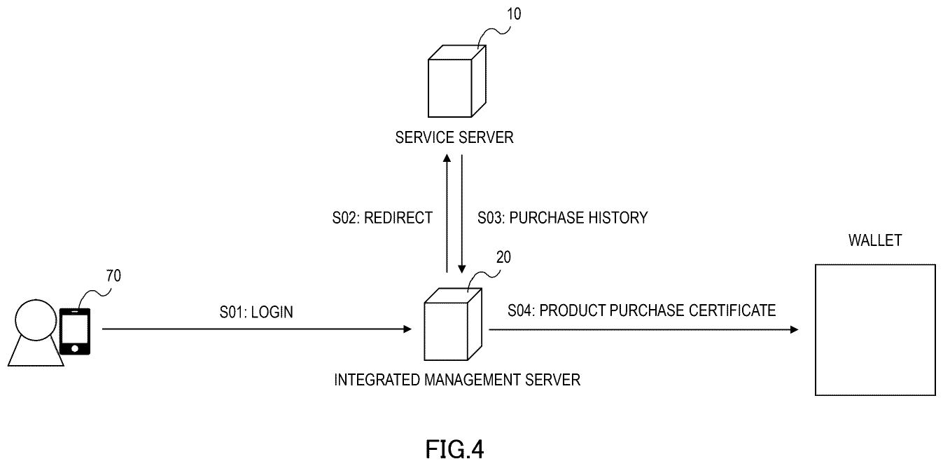

To purchase the figure, the user logs into an account of the integrated management server 20 (step S01 in FIG. 4). The integrated management server 20 displays a list of EC sites on the terminal 70, thereby allowing the user to select an EC site.

The integrated management server 20 redirects the connection destination of the terminal 70 to a login page of the EC site selected by the user (step S02). Specifically, the integrated management server 20 transmits to the terminal 70 a URL (Uniform Resource Locator) for logging into an account of the EC site selected by the user.

The URL transmitted to the terminal 70 is a URL for redirection for connecting the terminal 70 to a login page of the EC site, and the URL for redirection includes login information (ID and password) of the user embedded therein.

Upon receiving the URL for redirection, the terminal 70 accesses the login page of the EC site in accordance with the URL. At that time, since the URL for redirection includes login information, the EC site (the service server 10) acquires login information of the user and performs authentication.

The user purchases a figure on the EC site into which the user has logged in.

The EC site stores a purchase history of a product (the figure) purchased by the user. Specifically, the EC site (the service server 10-1) stores, as a purchase history, information such as a product name, product code, price, purchase date, and manufacturer name of the sold product.

It should be noted that a person in charge of the EC site or the like acquires information such as a product name and a product code from a manufacturer or the like of the product, and registers the acquired information in the service server 10.

The integrated management server 20 acquires a purchase history related to a product purchased by the user on the EC site. For example, the integrated management server 20 accesses an EC site on which the user has previously logged in, at regular intervals or at a predetermined timing, and acquires a purchase history of a product purchased by the user on the EC site.

For example, the integrated management server 20 acquires a purchase history including information of a purchased product (for example, a product name, a product code, a price, a purchase date, a manufacturer name, or the like) (step S03). The integrated management server 20 stores the purchase history of the user in an account of the user.

It should be noted that the integrated management server 20 acquires a play history of the game by the user with respect to a product sold in an online game, and extracts a purchase history of a product or the like purchased by the user from the play history. The integrated management server 20 stores the extracted purchase history (purchase history of a character) in an account of the user.

### Purchase of NFT Content of Purchased Product

A user who has purchased a product is able to purchase digital content corresponding to the purchased product. For example, in a case where a user has purchased a figure, the user is able to purchase a 3D model (3D data) of the figure. Alternatively, in a case where a user has purchased a character used in a game, the user is able to purchase a 3D model of the character.

It should be noted that a 3D model refers to a three-dimensionally depicted graphic used in a 3D game or a metaverse space and is three-dimensional shape data. The 3D model is 3D shape information such as a polygon model composed of a combination of faces, edges, and vertices, or a sculpt model composed of a large number of polygons. The 3D model is data having a variable shape, in which positional relationships or angles of an object can be changed, or a texture of a surface of the object can be changed while maintaining the shape.

Alternatively, in a case where a user has purchased a CD or a DVD, the user is able to purchase sound source data of each song stored in the CD or video data such as a movie stored in the DVD. Alternatively, in a case where a user has purchased a book or an electronic book, the user is able to purchase book data in which contents of the book have been digitized.

Digital content corresponding to a product purchased by a user is NFT-ized. It should be noted that, in the following description, NFT-ized digital content corresponding to a product purchased by a user is referred to as “NFT content.”

A user who desires to purchase NFT content logs in to the integrated management server 20. The user makes a request to the integrated management server 20 (platform business operator) for issuance of a purchase certificate of a product corresponding to the NFT content the user desires to purchase. Specifically, in a case where a user performs a predetermined operation (for example, pressing a purchase certificate issuance button), the integrated management server 20 displays, on the terminal 70, a list of products already purchased by the user. The user selects, from among the displayed list of products, a product for which the user desires to purchase NFT content.

In a case where the user selects a product, the integrated management server 20 issues a purchase certificate of the product selected by the user. Specifically, the integrated management server 20 issues a purchase certificate of the product, the certificate including information for identifying a purchaser of the product and information related to the product, and setting a platform business operator as an issuer.

For example, the integrated management server 20 issues a purchase certificate of the product in which a wallet address is set as the information for identifying a purchaser of the product and in which product-related information includes a product name, a product code, a price, a purchase date, a name of a manufacturer, or the like.

In the first example embodiment, a case will be described in which the integrated management server 20 issues a purchase certificate of the product as an SBT (SoulBound Token).

First, a person in charge of the platform business operator or the like generates a smart contract for issuing the purchase certificate of the product including the above-described content, and deploys the generated smart contract to a blockchain.

In a case where the purchase certificate of the product is required to be issued, the integrated management server 20 calls a function of the smart contract and inputs information necessary for issuing the purchase certificate of the product (such as a wallet address, product-related information, and an ID of the platform business operator).

By executing the smart contract, the wallet of the user (wallet address) is associated with the SBT issued as the purchase certificate of the product.

As described above, the integrated management server 20 issues, as the purchase certificate of the product, an SBT in which the platform business operator is an issuer and the purchaser of the product is an owner (step S04).

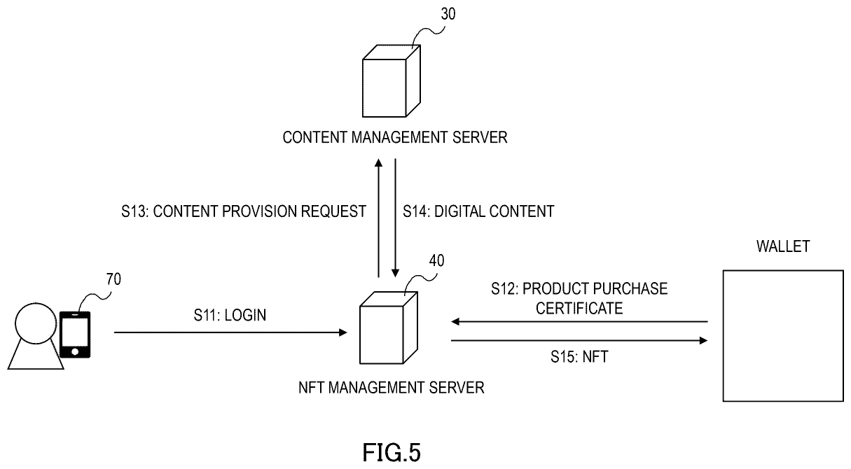

By receiving the issuance of the purchase certificate of the product, the user is able to purchase NFT content. In this case, the user logs into a marketplace provided by the NFT management server 40 (step S11 in FIG. 5).

In a case where the user performs a predetermined operation (for example, presses an NFT content purchase button), the NFT management server 40 acquires the purchase certificate of the product from the wallet of the user by using the wallet address of the user (step S12). The NFT management server 40 displays, on the terminal 70, a list of products corresponding to the purchase certificates of the products owned by the user.

The user selects a product, from the displayed list of products, for which the purchase of NFT content is desired.

In a case where the user selects a product, the NFT management server 40 verifies the purchase certificate of the product corresponding to the product selected by the user. For example, the NFT management server 40 determines whether or not the issuer of the purchase certificate of the product is a predetermined issuer (that is, determines whether or not the issuer is a reliable platform business operator).

In a case where the verification of the purchase certificate of the product is successful, the NFT management server 40 acquires the digital content to be sold (digital content to be converted into an NFT) and accompanying information related thereto from the content management server 30. Specifically, the NFT management server 40 acquires the digital content and the accompanying information from the content management server 30 of the IP holder of the product corresponding to the NFT content.

For example, in a case where the user desires to purchase NFT content corresponding to a figure purchased by the user, the NFT management server 40 acquires digital content (a 3D model) related to the figure from the content management server 30 managed by the manufacturer of the figure.

Alternatively, in a case where the user desires to purchase NFT content corresponding to a CD purchased by the user, the NFT management server 40 acquires digital content (audio data) of the CD from the content management server 30 managed by the record company.

Alternatively, in a case where the user desires to purchase NFT content corresponding to a character used in a game, the NFT management server 40 acquires digital content (a 3D model) of the character from the content management server 30 managed by the game manufacturer.

Specifically, the NFT management server 40 transmits information for specifying a product corresponding to the NFT content that the user desires to purchase to the content management server 30. For example, the NFT management server 40 transmits a “content providing request” including a product code of a figure, a CD, a character, or the like to the content management server 30 (step S13).

The content management server 30 that has received the content providing request transmits digital content corresponding to the product code included in the request and accompanying information related thereto to the NFT management server 40 (step S14). For example, the content management server 30 transmits a response including a 3D model of a figure, a character, or the like and accompanying information related thereto to the NFT management server 40.

As the accompanying information related to the digital content, examples include information referred to at the time of use of the digital content (for example, a 3D model or audio data), information related to the usage restrictions of the digital content, or the like. A more detailed explanation related to the accompanying information of the digital content will be described below.

It should be noted that a manufacturer of figures, a record company, a game manufacturer, or the like registers, in advance, a product code for a product handled by the company, digital content (for example, a 3D model of a character, audio data of a CD), accompanying information related thereto, or the like in the content management server 30. The manufacturer or the like registers the digital content and the accompanying information in the content management server 30 in accordance with its own policies or the like.

Before or after the acquisition of the digital content, in a case where payment for the NFT content has been completed, the NFT management server 40 issues an NFT whose owner is the purchaser of the NFT content (step S15). Specifically, the NFT management server 40 issues (generates) an NFT by using a smart contract, wherein the purchaser of the product is set as the owner and the NFT issuing business operator is set as the issuer.

More specifically, the NFT management server 40 issues an NFT including, as metadata, product information serving as a basis of NFT content (for example, a product name, a product code, a price, or the like) and a description of the NFT content (a type of the NFT content; for example, a 3D model), or the like. It should be noted that the metadata is configured to be updatable after issuance of the NFT. For example, in order that an issuer of the NFT or the like can update the metadata after issuance of the NFT, the metadata is stored in storage other than a blockchain. Alternatively, a dynamic NFT in which the content is updated by a smart contract may be used.

In a case where the NFT of the NFT content is issued, the user's wallet (wallet address) is associated with the NFT of the NFT content. It should be noted that the NFT content (digital content) and the accompanying information related thereto are stored in storage of the NFT management server 40. A link (URL) for accessing a storage destination of the NFT content or the like is described in the NFT.

A user logs in to a marketplace and is able to check the NFT content (digital content) stored in the NFT management server 40.

### Use of NFT Content in Metaverse Space

A user who has purchased NFT content is able to use the NFT content in a metaverse space.

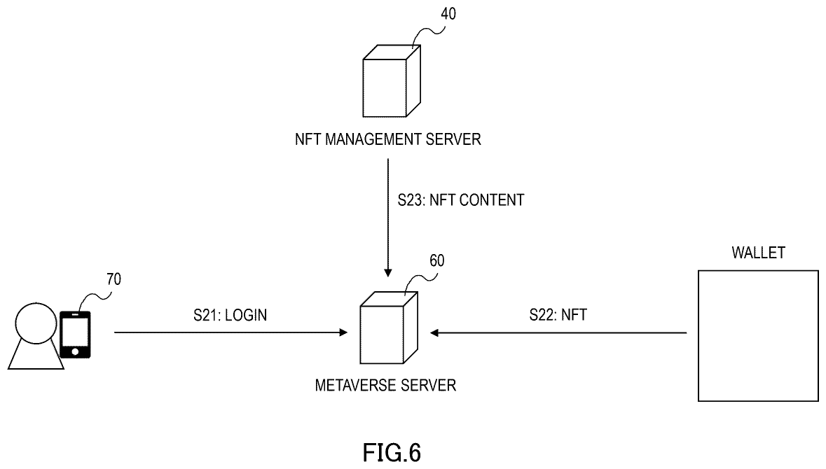

A user who intends to use the NFT content in the metaverse space logs in to the metaverse server 60 (step S21 in FIG. 6). The user instructs the logged-in metaverse server 60 to acquire the NFT content. In response to the instruction, the metaverse server 60 accesses the wallet of the user and acquires the NFT corresponding to the NFT content owned by the user (step S22).

In a case where the NFT has been acquired, the metaverse server 60 displays, on the terminal 70, a list of information related to the NFT content corresponding to the acquired NFT, thereby allowing the user to select NFT content (NFT content desired to be used in the metaverse). For example, the metaverse server 60 displays, on the terminal 70, a list of product names corresponding to the NFT content (for example, a figure name, a CD title, a character name).

Subsequently, the metaverse server 60 accesses the NFT management server 40 and acquires the NFT content and the like corresponding to the NFT selected by the user (step S23). The user can use the acquired NFT content in the metaverse space.

For example, the metaverse server 60 acquires from the user the usage mode of the acquired NFT content. As one example, in a case where the user owns NFT content of a figure, the user is able to display the figure in the user's own room on the metaverse. As another example, in a case where the user owns NFT content of a CD, the user is able to reproduce in the user's own room the audio data corresponding to the CD. As yet another example, in a case where the user owns NFT content corresponding to a game character, the user is able to place the character in the user's own virtual room in the metaverse space.

At that time, the metaverse server 60 uses accompanying information obtained together with the NFT content to utilize the NFT content (for example, a 3D model of a character used in a game) in the metaverse space. For example, the metaverse server 60 models the character in the metaverse space with a height specified by the game manufacturer. Alternatively, the metaverse server 60 models in the metaverse space a CD jacket obtained from the accompanying information. Alternatively, in a case where the usage mode of the NFT content is specified by a rights holder or the like as accompanying information, the user is allowed to use the NFT content only in the specified usage mode. For example, in a case where the usage mode of a 3D model of a character is specified as “for display in space only,” the user is not allowed to use the 3D model as an avatar. For example, in a case where the usage mode of a 3D model of a weapon is specified as “for use only as an accessory,” the user is not allowed to place the 3D model in the space.

Next, details of the individual apparatuses included in the information processing system according to the first example embodiment will be described.

### Integrated Management Server

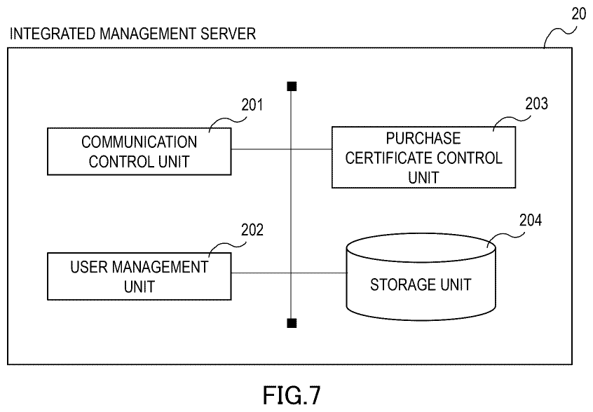

FIG. 7 is a diagram showing an example of a processing configuration (processing modules) of the integrated management server 20 according to the embodiment of the present disclosure. Referring to FIG. 7, the integrated management server 20 includes a communication control unit 201, a user management unit 202, a purchase certificate control unit 203, and a storage unit 204.

The communication control unit 201 is means for controlling communication with other apparatuses. For example, the communication control unit 201 receives data (packets) from the terminal 70. In addition, the communication control unit 201 transmits data to the terminal 70. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user management unit 202 is means for performing control and management related to a user.

The user management unit 202 acquires information such as a name, a gender, a date of birth, and login information (an ID, a password, or the like) from a user who has accessed a predetermined website (for example, a user registration site). Furthermore, the user management unit 202 acquires a wallet address of the user and login information for logging into each service server 10 in which the user has created an account.

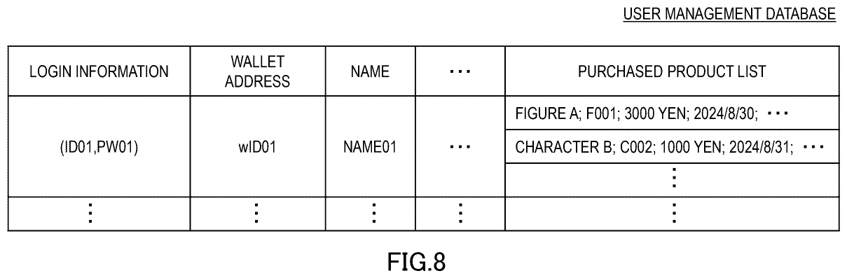

The user management unit 202 stores the acquired name, wallet address, and login information for logging into the service server 10 in a user management database (see FIG. 8). The user management unit 202 associates and stores, in each user's account, the information of the service server 10 (EC site, game server) with the login information. Note that the user management database shown in FIG. 8 is an example, and is not meant to limit the items to be stored. For example, the user management database may store biometric information of the user (for example, a face image).

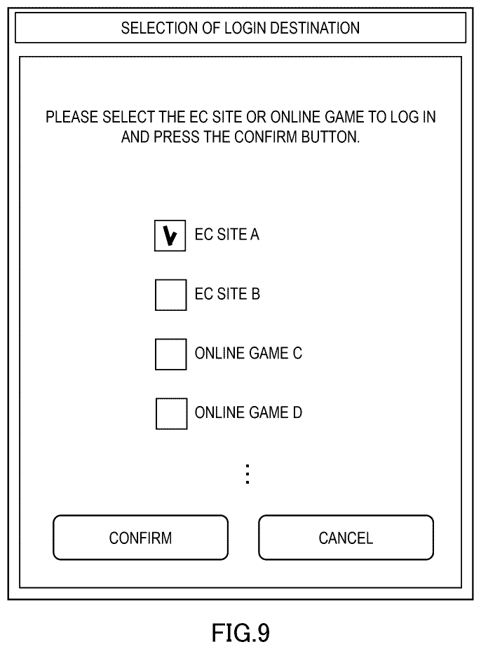

The user management unit 202, in a case where a logged-in user desires to purchase a product or play a game, displays on the terminal 70 possessed by the user a list of EC sites and game servers into which the user is able to log in. For example, the user management unit 202 displays, on the terminal 70, a GUI (Graphical User Interface) as shown in FIG. 9, and enables the user to select an EC site or an online game.

Upon the user selecting an EC site or an online game to log into, the user management unit 202 redirects the connection destination of the terminal 70 to the login page of the EC site or the like selected by the user. In this case, the user management unit 202 transmits to the terminal 70 a URL for redirection into which the login information of the logged-in user's account (login information corresponding to the EC site or the like to be logged into) is embedded.

The purchase certificate control unit 203 is means for performing control relating to purchase certificates for products purchased by the user. Specifically, the purchase certificate control unit 203 issues, to the user who has purchased a product (for example, a figure, a CD, or a game character), a purchase certificate for the product as an SBT. More specifically, the purchase certificate control unit 203 issues, to the user, an SBT proving that the user has purchased the product, using the wallet address of the user.

The purchase certificate control unit 203 accesses, at regular intervals or at predetermined timings, each EC site or game server (service server 10) for which login information is registered in the user's account. The purchase certificate control unit 203 logs into the EC site or the like using the login information corresponding to each EC site or game server.

The purchase certificate control unit 203 acquires, from the purchase history page of the logged-in service server 10, the purchase history of products purchased by the user. Alternatively, the purchase certificate control unit 203 acquires, from the play history page of the logged-in service server 10, the play history of games played by the user.

Alternatively, the purchase certificate control unit 203 may, while logged into the service server 10, acquire the user's purchase history or play history by using an API (Application Programming Interface) or the like predetermined by the service provider.

Upon acquiring the purchase history of products, the purchase certificate control unit 203 stores, in the purchased product list field of the user management database, information on the products purchased by the user (for example, product name, product code, price, purchase date, manufacturer name, and so on) as well as information on the EC site or the like from which the product was purchased.

Alternatively, upon acquiring a gameplay history of a game, the purchase certificate control unit 203 extracts a purchase history of items (for example, characters, weapons, accessories, items, and skins such as armor, clothing, and innerwear) from the gameplay history, and stores the information of the corresponding items in the user management database.

It should be noted that, in a case where the acquired purchase history is already stored in the user management database, the purchase certificate control unit 203 may either discard the acquired product purchase history or overwrite the corresponding purchase history.

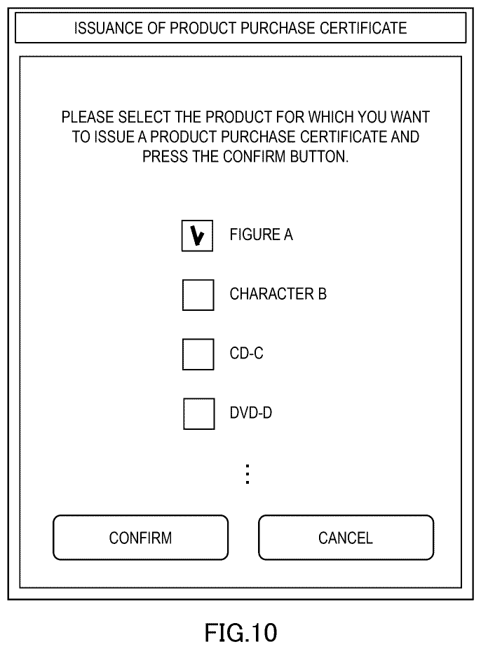

In a case where a user who has logged into an account desires issuance of a product purchase certificate, the purchase certificate control unit 203 displays a list of products purchased by the user (products listed in a purchased product list), and specifies a product for which the user desires issuance of the product purchase certificate. For example, the purchase certificate control unit 203 displays a GUI as illustrated in FIG. 10 to identify the product for which the user desires issuance of the product purchase certificate.

Once the user specifies the product for which the user wishes to have a product purchase certificate issued, the purchase certificate control unit 203 calls a function of a smart contract deployed on a node on the blockchain and issues an SBT of the product purchase certificate.

For example, the purchase certificate control unit 203 inputs, into the smart contract, the wallet address as the address of the recipient of the SBT and the wallet address of the platform operator as the ID of the issuer of the SBT. Furthermore, the purchase certificate control unit 203 may also input into the smart contract, as information relating to the product purchased by the user, information such as the product name, product code, price, purchase date, and name of the manufacturer of the product.

The smart contract uses this information to issue, as a product purchase certificate, an SBT in which the purchaser of the product is set as the owner and the platform operator is set as the issuer, and which includes information relating to the purchased product in metadata.

It should be noted that the issuance of an SBT using a smart contract is not the purpose of the present disclosure, and thus a more detailed description thereof will be omitted.

The storage unit 204 is means for storing information necessary for the operation of the integrated management server 20. For example, the storage unit 204 stores, in association, the names of EC sites and online games with the URLs of their login pages.

### NFT Management Server

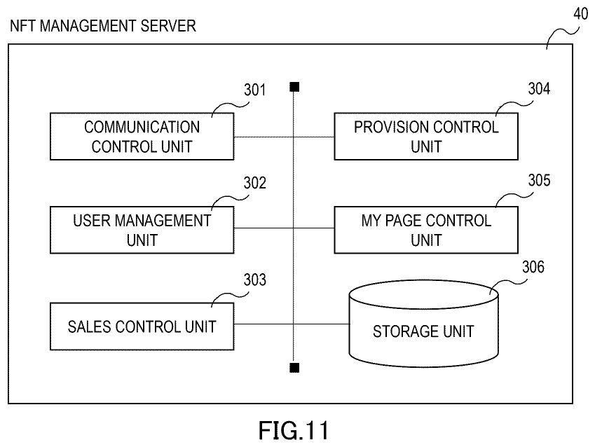

FIG. 11 is a diagram showing an example of a processing configuration (processing modules) of the NFT management server 40 according to the embodiment of the present disclosure. Referring to FIG. 11, the NFT management server 40 includes a communication control unit 301, a user management unit 302, a sales control unit 303, a provision control unit 304, a my page control unit 305, and a storage unit 306.

The communication control unit 301 is means for controlling communication with other apparatuses. For example, the communication control unit 301 receives data (packets) from the terminal 70. In addition, the communication control unit 301 transmits data to the terminal 70. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user management unit 302 is means for performing control and management related to a user.

The user management unit 302 acquires information such as a name, a gender, a date of birth, and login information (an ID, a password, or the like) from a user who has accessed a predetermined website (for example, a user registration site). In addition, the user management unit 302 acquires a wallet address. The user management unit 302 stores the acquired name, login information, wallet address, or the like in a predetermined database.

The sales control unit 303 is means for executing control relating to the sale of NFT content.

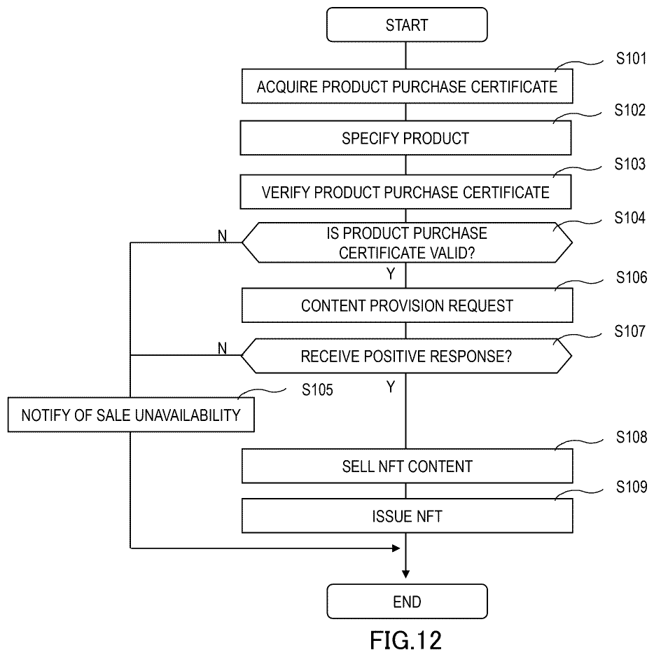

FIG. 12 is a flowchart showing one example of the operation of the sales control unit 303 according to the embodiment of the present disclosure. The operation of the sales control unit 303 will be described with reference to FIG. 12.

In a case where a user who has logged into the marketplace desires to purchase NFT content, the sales control unit 303 connects to the user's wallet by using the wallet address of the user. The sales control unit 303 acquires a product purchase certificate (SBT) associated with the user's wallet (step S101).

The sales control unit 303 acquires, from the acquired product purchase certificate, information on the product purchased by the user (for example, product name, product code, price, purchase date, name of manufacturer, and the like). The sales control unit 303 specifies, using the acquired product information, the product corresponding to the NFT content that the user desires to purchase (step S102).

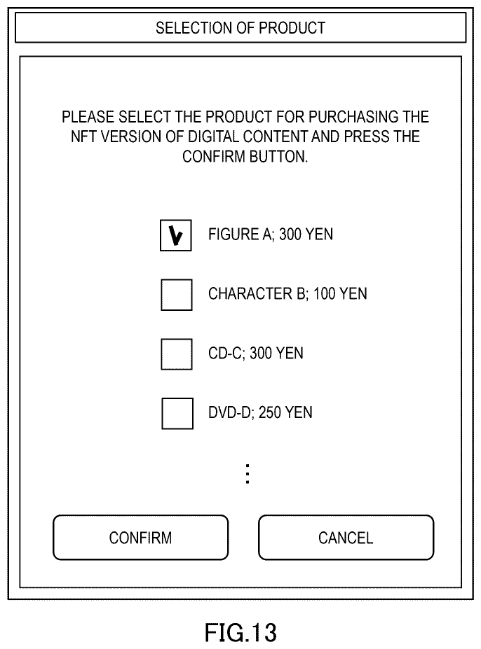

For example, the sales control unit 303 displays, on the terminal 70, a GUI such as that shown in FIG. 13 to specify the product corresponding to the NFT content that the user desires to purchase. In this case, the sales control unit 303 may present the price of the NFT content to the user, as shown in FIG. 13.

It should be noted that the sales control unit 303 may acquire the price of the NFT content by making an inquiry to the content management server 30 regarding the price of the NFT content. Alternatively, the price of the NFT content may be set to a price obtained by multiplying the price of the corresponding product by a predetermined coefficient.

In a case where the user finishes selecting the NFT content to be purchased, the sales control unit 303 performs verification of the product purchase certificate corresponding to the NFT content selected by the user (step S103).

Specifically, the sales control unit 303 performs verification relating to the issuer of the product purchase certificate. For example, the sales control unit 303 determines whether the ID of the issuer of the product purchase certificate (for example, the wallet address of the platform operator) is registered in advance as an ID of a platform operator with which transactions are conducted.

In a case where the ID of the issuer is registered, the sales control unit 303 determines that the product purchase certificate corresponding to the NFT content that the user desires to purchase is valid (determines that the verification of the product purchase certificate has succeeded). In a case where the ID of the issuer is not registered, the sales control unit 303 determines that the product purchase certificate corresponding to the NFT content that the user desires to purchase is invalid (determines that the verification of the product purchase certificate has failed).

In a case where the product purchase certificate is invalid (step S104, No branch), the sales control unit 303 notifies the user that the NFT content cannot be sold (notifies of sale unavailability; step S105).

In a case where the product purchase certificate is valid (step S104, Yes branch), the sales control unit 303 acquires from the content management server 30 the digital content to be sold to the user and the accompanying information related thereto. Specifically, the sales control unit 303 transmits, to the content management server 30 of the manufacturer or game manufacturer described in the product purchase certificate, a content provision request including a product code of the product corresponding to the digital content (step S106).

It should be noted that the sales control unit 303 refers to table information in which the name of the IP holder (manufacturer, game manufacturer) is associated with information (for example, an address) of the corresponding content management server 30, and specifies the content management server 30 to which the content provision request is to be transmitted.

The sales control unit 303 receives, from the content management server 30, a response (positive response, negative response) to the content provision request.

In a case where a negative response indicating that the digital content cannot be provided is received (step S107, No branch), the sales control unit 303 notifies the user that the NFT content cannot be sold (notifies of sale unavailability; step S105).

In a case where a positive response indicating that the digital content can be provided is received (step S107, Yes branch), the NFT content is sold to the user (step S108).

The user pays the price of the NFT content using cryptocurrency such as Bitcoin or Ethereum. Alternatively, a credit card or electronic money may be used for payment of the price of the NFT content.

It should be noted that all or part of the price for the NFT content paid by the user is paid to the corresponding IP holder (manufacturer, game manufacturer, or the like).

In a case where settlement relating to the sales price for the NFT content has been completed, the sales control unit 303 issues the NFT of the NFT content (step S109). The sales control unit 303 issues the NFT of the digital content acquired from the content management server 30 by using a smart contract.

Here, a person in charge of the platform business operator, or the like, creates in advance the smart contract for issuing the NFT of the NFT content. The person in charge, or the like, deploys the smart contract to the blockchain.

The sales control unit 303 issues the NFT of the NFT content by using the smart contract for NFT issuance.

The smart contract for NFT issuance issues an NFT in which a purchaser of NFT content is an owner, and which includes information of the NFT content (for example, a name of a corresponding product, a manufacturer name, or the like) as metadata. It should be noted that the NFT content and accompanying information are stored in storage of the NFT management server 40 that is accessible from the outside. By execution of the smart contract for NFT issuance, a link to storage in which the NFT content or the like is stored is described in the NFT. In addition, metadata of the NFT is also stored in the storage of the NFT management server 40. Information described in the metadata includes a product purchase date, an issuance date of a product purchase certificate, a purchase date of NFT content (an NFT issuance date), or the like.

As described above, the sales control unit 303 includes a function as an acquisition means and a function as a generation means. The acquisition means acquires a 3D model corresponding to a product purchased by the user and accompanying information thereof. The accompanying information includes, for example, size information which is information serving as a standard for the size of the product in the metaverse space. The generation means generates (issues) an NFT (Non-Fungible Token) for the acquired 3D model by using the acquired 3D model and accompanying information (for example, size information). For example, the generation means manages the 3D model and accompanying information (size information) acquired from the content management server 30 so as to be externally available, and generates an NFT in which the purchaser of the product is the owner.

It should be noted that the sales control unit 303 may generate an NFT for the 3D model acquired from an IP holder (the content management server 30) by using not only the size information but also whole body information and appearance information.

The provision control unit 304 is means for executing control relating to provision of NFT content and accompanying information thereof. In a case where an external server (for example, the metaverse server 60) accesses storage in accordance with a link described in the NFT of the NFT content, the provision control unit 304 externally provides the NFT content and accompanying information stored in the storage.

In other words, the provision control unit 304 has a function as a utilization means for controlling the 3D model for which the NFT has been generated so as to be available in the metaverse space. The provision control unit 304 provides the 3D model for which the NFT has been generated and accompanying information thereof to the metaverse server 60 in response to a request from the metaverse server 60. The provided 3D model and accompanying information (for example, size information) are used in the metaverse server 60.

The my page control unit 305 is a means for performing control related to an account (a my page) of a user. The my page control unit 305 includes a function as an acquisition means for acquiring an NFT (Non-Fungible Token) issued by the fact that a user has purchased a product, and a function as a display control means for displaying information related to the acquired NFT.

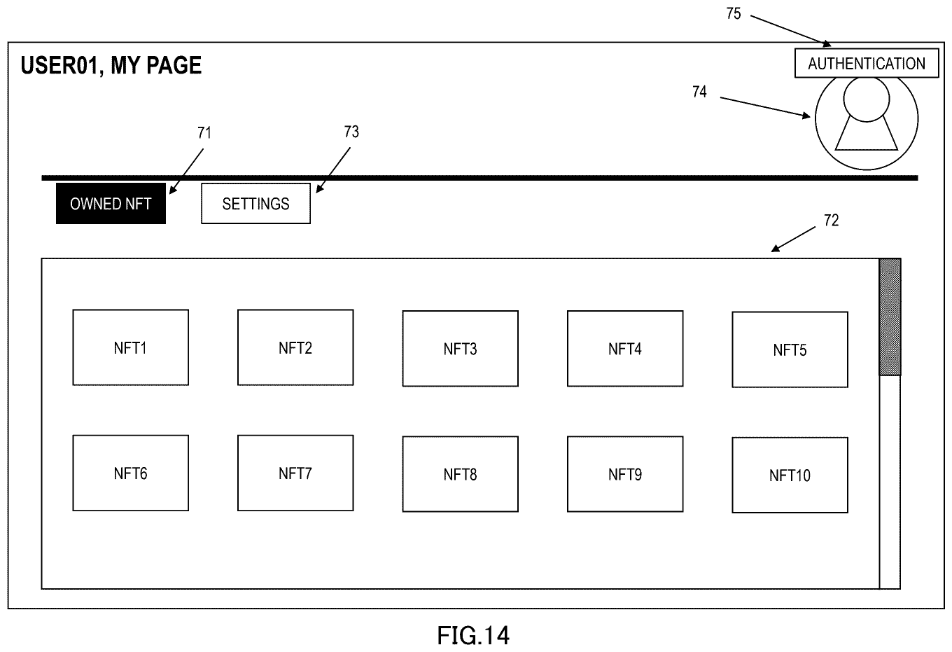

The my page control unit 305 displays, on the terminal 70, a my page as shown in FIG. 14 in a case where a user logs into a marketplace.

As shown in FIG. 14, in a case where an owned NFT button 71 is pressed (activated), the my page control unit 305 displays a list of NFTs owned by the user in an NFT display area 72. The my page control unit 305 accesses a wallet address of the user and acquires NFTs owned by the user. The my page control unit 305 generates a screen as shown in FIG. 14 by using the acquired NFTs.

The my page control unit 305 enables various settings related to the my page in a case where a setting button 73 is pressed.

In addition, the my page control unit 305 displays an icon of the user in an icon display area 74 of the my page. The my page control unit 305 may change an icon displayed in the icon display area 74 or the like in accordance with a setting change.

Here, in generating an account of a user, the NFT platformer may perform personal identification of the user. For example, the user management unit 302 may perform personal identification using a selfie face image of the user and a face image obtained by a passport or the like. The user management unit 302 may manage and store, in a manner of distinction, a user who has been subjected to personal identification as an “authenticated user,” and a user who has not been subjected to such identification as an “unauthenticated user.”

The my page control unit 305 may display, in the my page, the fact that a user who has logged into an account is an authenticated user. For example, as shown in FIG. 14, the my page control unit 305 may display an authentication mark 75 at an upper portion of the icon display area 74. In this manner, in a case where the user is an authenticated user approved by the NFT platformer, the my page control unit 305 may display, in a transaction history of NFTs, the fact that the user is the authenticated user.

Alternatively, the my page control unit 305 may calculate a transaction volume and a transaction amount of NFTs during a predetermined period for each user, and grant each user a title or the like corresponding to the transaction volume. For example, the my page control unit 305 may give a title such as “Transaction Volume No. 1” to a user having the largest transaction volume (the number of sales and the number of purchases of NFTs).

Alternatively, the my page control unit 305 may give a title such as “Transaction Amount No. 1” to a user having the largest transaction amount (a total amount of NFTs sold and NFTs purchased) during the predetermined period.

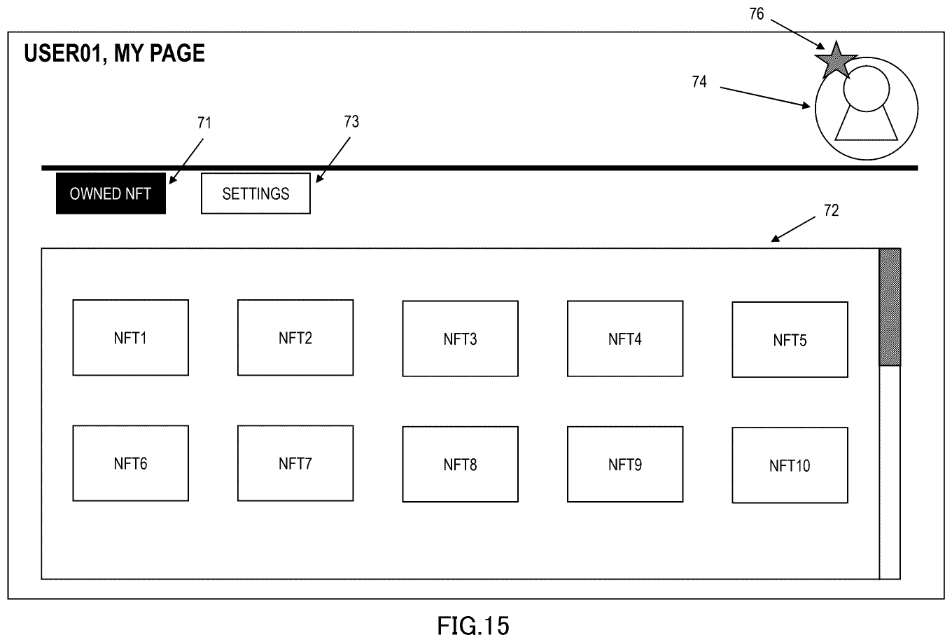

The my page control unit 305 may display the title in the my page. For example, as shown in FIG. 15, the my page control unit 305 may display, in place of or in addition to the authentication mark 75 displayed in the icon display area 74 of the my page, a mark 76 corresponding to a title given to the user.

For example, the my page control unit 305 displays, as the mark 76, a golden star for a user given a title of “Transaction Amount No. 1.” In this manner, the my page control unit 305 may display a title given to the user in accordance with a total quantity or a total amount of NFTs transacted by the user.

Alternatively, the my page control unit 305 may classify a plurality of users according to a transaction volume or a transaction amount of NFTs, and give titles to the classified users. For example, the my page control unit 305 may give a title such as “Gold User” to up to the top 100 users having the largest transaction volume. The my page control unit 305 may display, in the my page, the mark 76 corresponding to the gold user.

The my page control unit 305 may display a tag set for an NFT. More specifically, the my page control unit 305 may display tags (hashtags) for NFTs listed in the my page (NFTs displayed in the NFT display area 72).

The tag may be assignable by a user. Alternatively, the my page control unit 305 may extract (calculate) a tag from information described in metadata of the NFT or the like.

Examples of tags of an NFT include a series name of a game in which a character appears (an IP name), a game name in which the character appears, a character name, an acquisition period of the character (for example, a tag such as #Season1), a type of pose, or the like. Alternatively, examples of tags of an NFT include a title in a game (for example, tags such as #LEV6, #SizeMAX, #DifferentColor, #LevelMAX), a market price of the same character (for example, a tag such as #SameCharacterExceed10000Yen), a milestone number (for example, #100thCharacter), or the like.

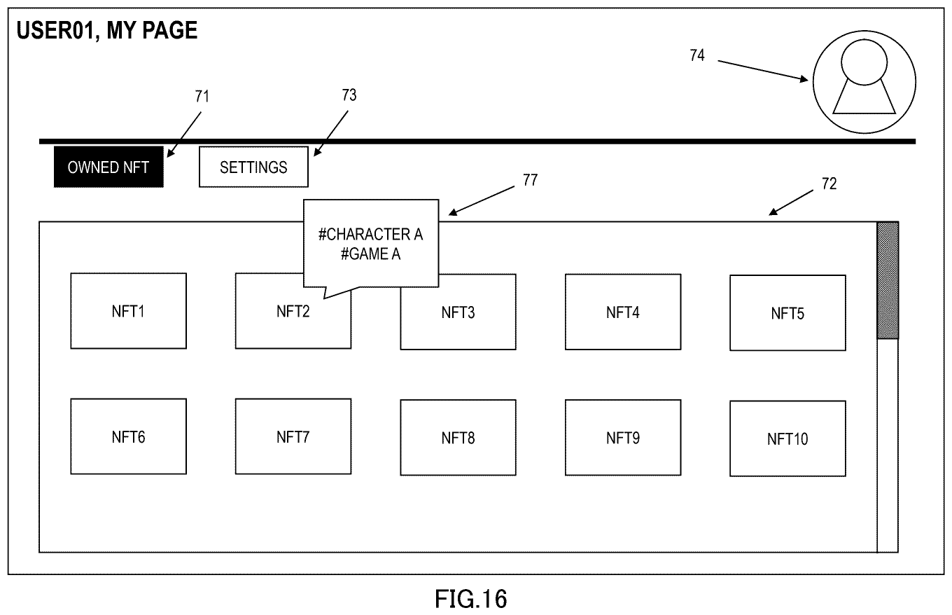

For example, as shown in FIG. 16, in a case where the my page control unit 305 detects a predetermined operation by a user with respect to an NFT (for example, clicking the NFT or moving a mouse) in the my page, the my page control unit 305 displays a tag of the NFT in a popup 77. Alternatively, the tag of the NFT may be displayed under the corresponding NFT. It should be noted that a tag set in the NFT platform may be displayed in a metaverse space, as will be described below.

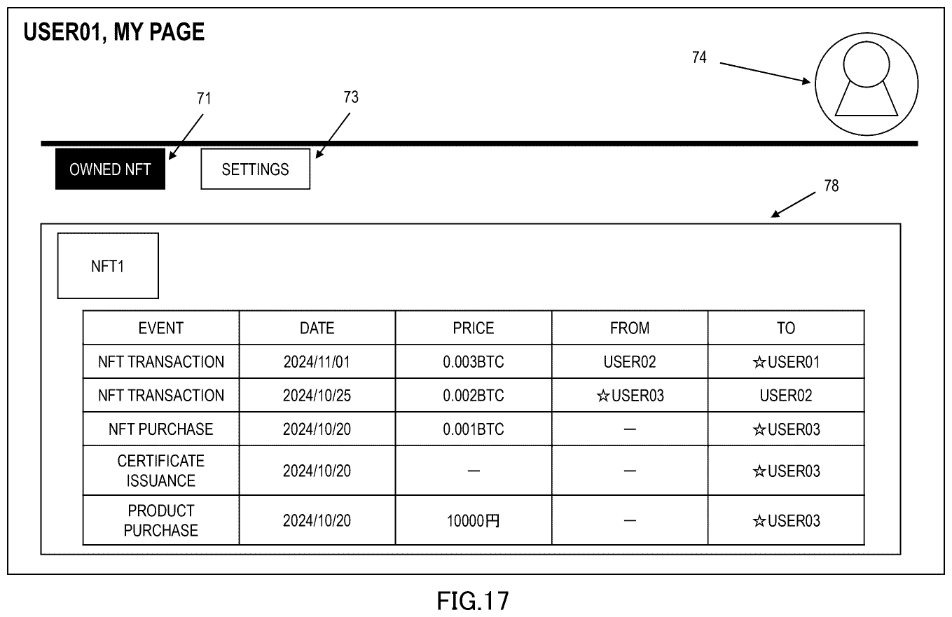

The my page control unit 305 displays a detailed transaction history of an NFT in a case where an NFT (an icon corresponding to the NFT) displayed in the NFT display area 72 is pressed. For example, in a case where “NFT1” shown in FIG. 14 or the like is pressed, the my page control unit 305 displays, on the terminal 70, a transaction history screen as shown in FIG. 17.

As shown in FIG. 17, the my page control unit 305 displays, in a transaction history area 78, a list of transaction histories of an NFT selected by a user. The my page control unit 305 displays, for the selected NFT, a product purchase date of a product that forms a basis thereof, a price, purchaser information (a user name), a date of issuance of a product purchase certificate, or the like. In addition, the my page control unit 305 displays an NFT purchase date, a price, purchaser information, and information at the time of an NFT transaction (resale), such as a date, a price, a seller, and purchaser information. In this manner, the my page control unit 305 may display a fact related to purchase of a product as part of a transaction history of the NFT.

It should be noted that in a case where the NFT is obtained by achievement of a condition in a game, the my page control unit 305 may display, in the transaction history screen, a condition achievement date in the game or the like.

In a transaction history, information of a user who purchased a product, a user who received issuance of a product purchase certificate, and a user who purchased an NFT is described in a TO column of a transaction history screen.

The my page control unit 305 may display the fact in a case where a user described in the transaction history (a user described in a FROM column and a TO column) is an authenticated user. For example, as shown in FIG. 17, the my page control unit 305 may add a white star mark in front of a user name.

Alternatively, the my page control unit 305 may display a title or the like corresponding to the transaction volume or the transaction amount in the transaction history screen.

Alternatively, in a case where a user name described in the FROM column or the like is clicked, the my page control unit 305 may display, by a popup display or the like, a type of the clicked user (an authenticated user, an unauthenticated user, a title corresponding to the transaction volume, or the like). Alternatively, the my page control unit 305 may display the fact in a case where a user displayed in the transaction history is a celebrity (a famous person authenticated by the NFT platformer).

Alternatively, in the transaction history screen shown in FIG. 17, the my page control unit 305 may display a tag assigned to the NFT. For example, in the example of FIG. 17, a tag may be displayed in a popup near “NFT1.”

It should be noted that the my page control unit 305 enables setting changes between display and non-display of a star mark indicating that a user displayed in the FROM column or the like is the authenticated user.

The NFT management server 40 may support a cross-chain bridge (a token bridge) that transfers NFTs between different NFT platforms. In that case, the my page control unit 305 may display the transaction history of the NFT before and after the cross-chain bridge in a distinguishable manner.

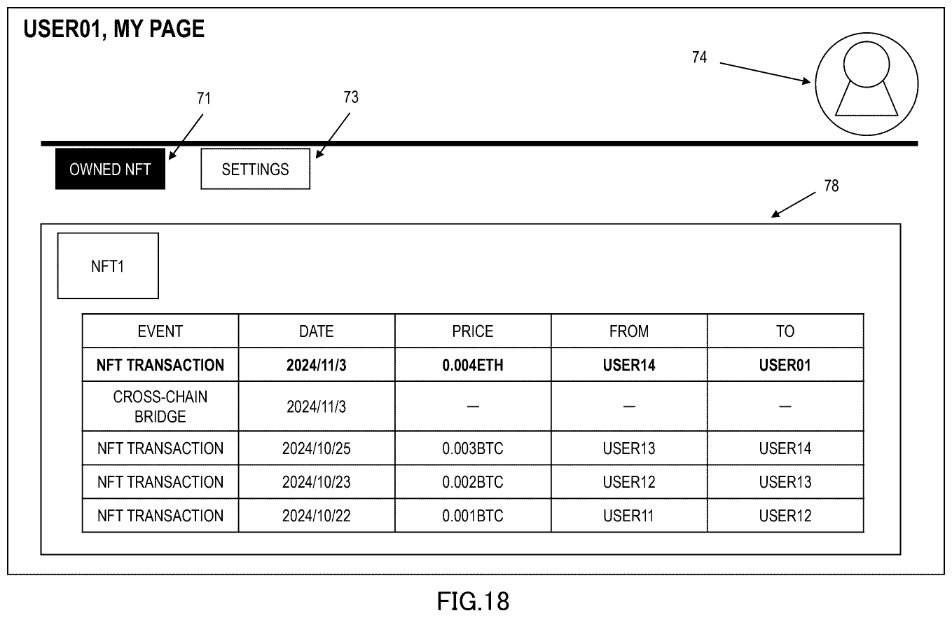

That is, the NFT management server 40 may display a history including transactions before the bridge for an NFT accepted by a cross-chain bridge. For example, in the transaction history shown in FIG. 18, the transaction history up to the third row from the bottom is a transaction history before the cross-chain bridge.

In addition, the my page control unit 305 may display, in the transaction history, the fact that the cross-chain bridge has been performed (see the second row from the top of the transaction history shown in FIG. 18).

Further, the my page control unit 305 may display transactions before and after the cross-chain bridge in a manner identifiable by a user. For example, the my page control unit 305 may change colors or the like of information displayed in the transaction history before and after execution of the cross-chain bridge. In the example of FIG. 18, transactions after the cross-chain bridge are displayed in bold.

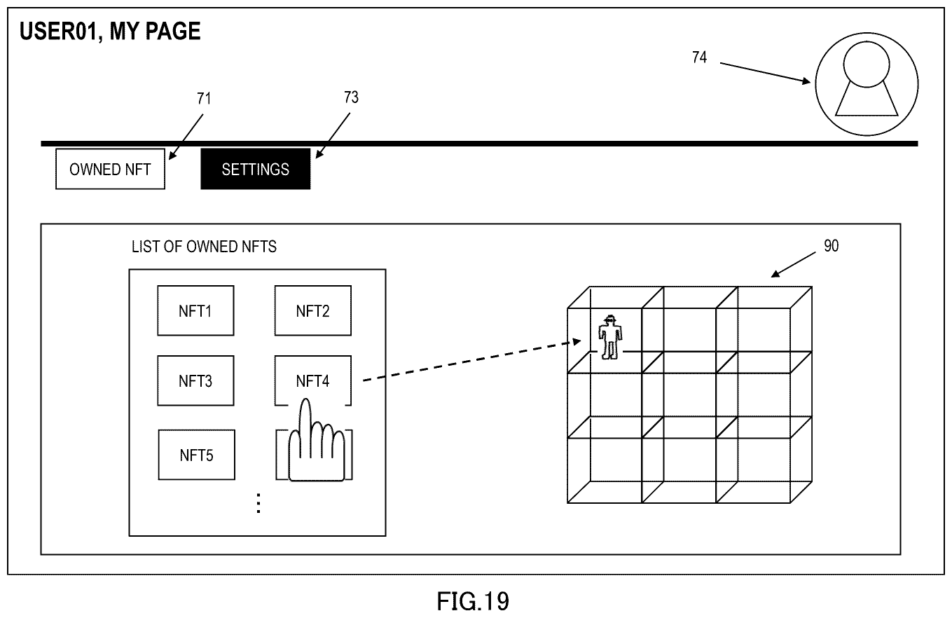

Alternatively, the my page control unit 305 may include a function of arranging NFT content (for example, a 3D model of a character) possessed by a user in a pseudo showcase. For example, in a case where a setting button 73 displayed in FIG. 14 or the like is pressed and a predetermined menu (for example, a pseudo showcase) is selected, the my page control unit 305 provides an interface as shown in FIG. 19.

In FIG. 19, a list of NFTs (NFT content) owned by a user and a pseudo showcase 90 are displayed. For example, the pseudo showcase 90 has 27 transparent blocks of cuboids having a predetermined length (for example, 2 m) in a real coordinate system arranged in a 30×3×3 manner. In the pseudo showcase 90, a character can be placed life-sized at each vertex or a center point of the block.

For example, a character set to a size of 2 m in the real world is arranged in the cuboid with a size from the floor to the ceiling. In contrast, a character set to a size of 1 m in the real world is arranged in the cuboid with a height equal to half of the height from the floor to the ceiling.

In FIG. 19, in a case where the user selects an NFT listed and drags and drops it to any cuboid of the pseudo showcase 90, a character corresponding to the selected NFT is arranged in the cuboid dropped. In the example of FIG. 19, a character corresponding to NFT4 is arranged in the upper left cuboid of the pseudo showcase 90.

It should be noted that the my page control unit 305 may enable selection of a camera setting in a case where a character is arranged in the pseudo showcase 90. For example, in a case of an extremely large character, the my page control unit 305 may allow selection of a camera viewpoint in which the character appears to be falling from the front toward the back of the cuboid.

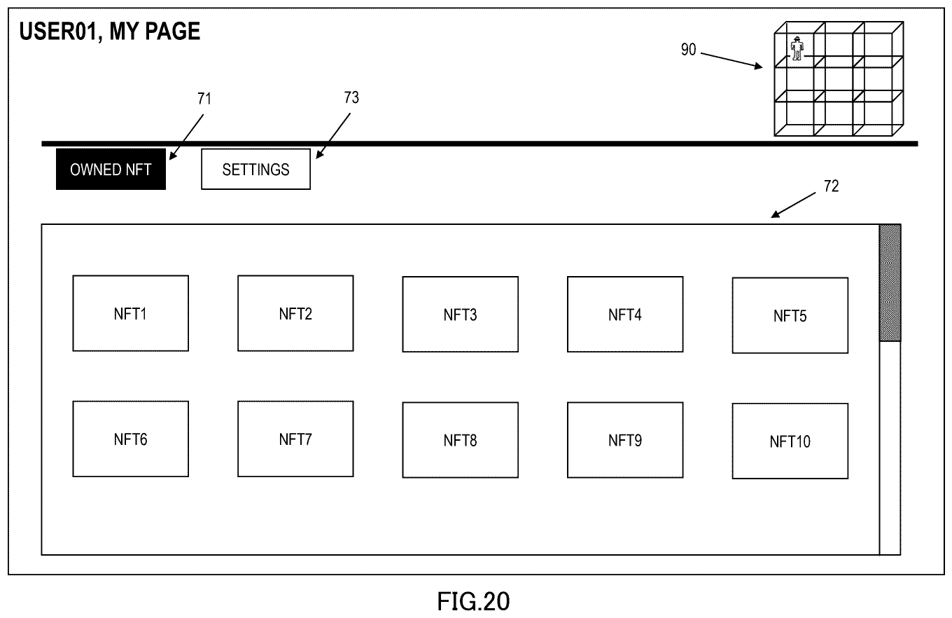

In this manner, the my page control unit 305 may display, in a pseudo showcase, digital content (NFT-converted digital content) corresponding to a purchased product of a user. In addition, the pseudo showcase 90 in which a character has been arranged may be displayed in a portion of the my page. For example, as shown in FIG. 20, the pseudo showcase 90 may be displayed on the my page instead of the icon display area 74.

The storage unit 306 is means for storing information necessary for the operation of the NFT management server 40.

### Metaverse Server

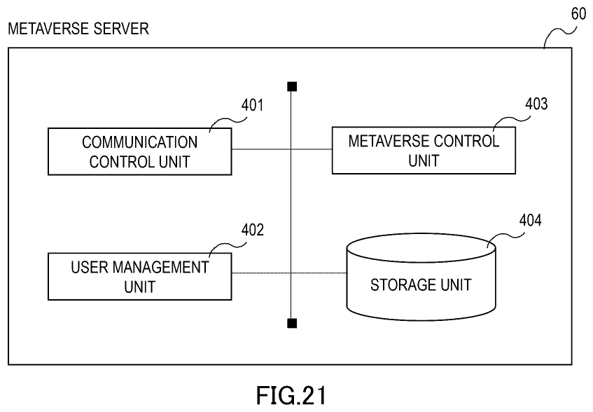

FIG. 21 is a diagram illustrating an example of a processing configuration (processing modules) of a metaverse server 60 according to an example embodiment disclosed in the present application. Referring to FIG. 21, the metaverse server 60 includes a communication control unit 401, a user management unit 402, a metaverse control unit 403, and a storage unit 404.

The communication control unit 401 is means for controlling communication with other apparatuses. For example, the communication control unit 401 receives data (packets) from the terminal 70. In addition, the communication control unit 401 transmits data to the terminal 70. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit for receiving data from other apparatuses, and a function as a transmitting unit for transmitting data to other apparatuses.

The user management unit 402 is means for performing control and management related to a user.

The user management unit 402 acquires information such as a name, a gender, a date of birth, login information (an ID, a password), and SNS information (for example, a follower ID, a followed ID, or the like) from a user who has accessed a predetermined website (for example, a user registration site). In addition, the user management unit 402 acquires a wallet address (a wallet address dealing with NFT content and virtual currency). The user management unit 302 stores the acquired name, login information, wallet address, or the like in a predetermined database.

The metaverse control unit 403 is means for performing control related to a metaverse (a virtual space, a virtual 3D space). Specifically, the metaverse control unit 403 implements a metaverse platform. The metaverse control unit 403 generates an avatar of the user and causes the generated avatar to operate in accordance with an operation of the user.

### My Room

In a case where a user creates an account in the metaverse server 60, the metaverse control unit 403 sets a “my room” of the user in the metaverse space. The metaverse control unit 403 generates a my room for each user. In a case where a user logs into the metaverse server 60, the metaverse control unit 403 displays an avatar of the user in the my room.

The user performs various activities in the my room. For example, the user can place a table or a television in the user's own room.

Further, the user is able to use purchased NFT content in the user's own room (the my room).

For example, in a case where a user who has logged into an account performs a predetermined operation (for example, pressing an NFT content acquisition button), the metaverse control unit 403 acquires NFT content possessed by the user.

Specifically, the metaverse control unit 403 connects to a wallet of the user using a wallet address of the user. The sales control unit 303 acquires NFTs of respective NFT contents associated with the wallet of the user.

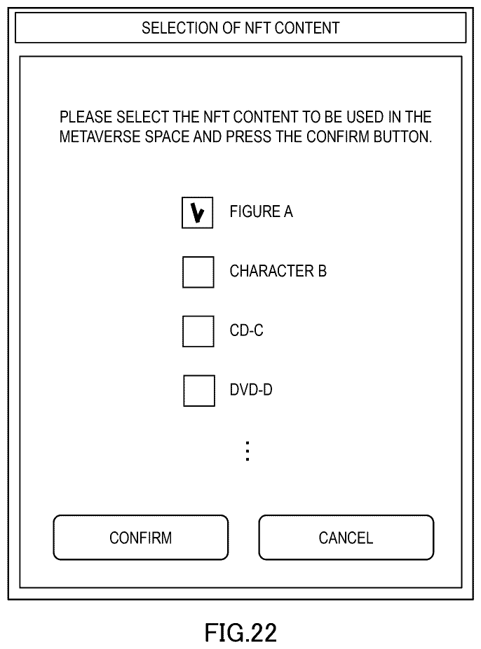

In a case where at least one or more NFTs owned by the user are acquired, the metaverse control unit 403 displays, on a terminal 70, a list of NFT contents possessed by the user using information acquired from the acquired NFTs. For example, the metaverse control unit 403 displays, on the terminal 70, a GUI as shown in FIG. 22, and enables selection of NFT content that the user desires to bring into the user's own room (the my room on the metaverse space).

In a case where the user selects NFT content to be brought into the my room, the metaverse control unit 403 accesses storage at a link described in an NFT corresponding to the NFT content acquired by the user, and acquires the NFT content and accompanying information.

In a case where the NFT content and the accompanying information are acquired, the metaverse control unit 403 uses the acquired NFT content and the accompanying information in the my room.

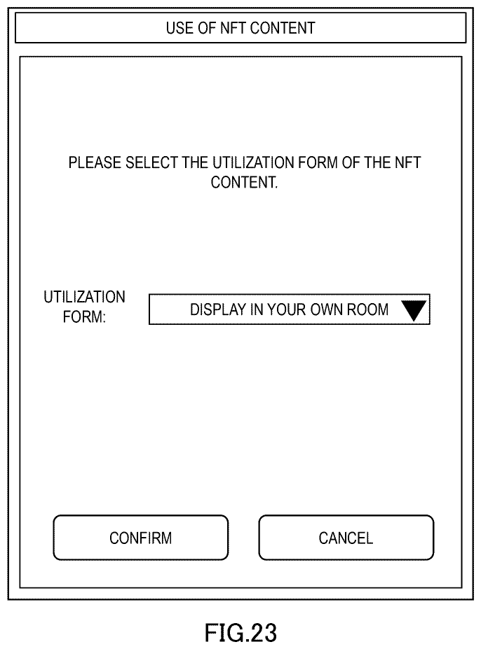

For example, before or after acquisition of the NFT content, the metaverse control unit 403 acquires, from the user, a utilization method (a utilization form) of the NFT content selected by the user. For example, in a case where NFT content (a 3D model) corresponding to a character in a game or an animation is selected, the metaverse control unit 403 displays, on the terminal 70, a GUI as shown in FIG. 23.

The metaverse control unit 403 presents the user with options for usage forms corresponding to the type of NFT contents selected by the user. For example, in a case where NFT contents (3D model) of a character are acquired, the metaverse control unit 403 presents the user with options related to the usage form of the NFT contents, such as “decorate in one's room” or “use as an avatar.”

The metaverse control unit 403 utilizes, on the metaverse, the NFT contents selected by the user in the usage form selected by the user.

Specifically, the metaverse control unit 403 performs control for using, in the metaverse space, a 3D model of a character acquired from an IP holder via the NFT management server 40. More specifically, the metaverse control unit 403 converts the NFT-ized 3D model so that it can be used on the metaverse space.

At that time, the metaverse control unit 403 uses, in addition to a 3D model of the character, information related to the size of the character in modeling in a metaverse space (size information), while utilizing the 3D model in the metaverse space.

In other words, the metaverse control unit 403 acquires the NFT contents (3D model of the character) and the size information, which is accompanying information, from an IP holder of the NFT contents.

Here, the size information is information indicating a size standard in the metaverse space for the 3D model of the character. For example, the size information is set to a value assuming that the character exists in the real world. For example, for a humanoid character, the size information is set to 180 cm, and for a monster character, the size information is set to 3 m.

In this way, the metaverse control unit 403 acquires 3D shape information of the character used in a 3D game (data for three-dimensionally displaying the character) and the size information related to the size in a case where the character is brought into the metaverse space.

In a case where 3D shape information and size information of a character purchased by the user in a game are acquired, the metaverse control unit 403 uses the 3D shape information and the size information to use NFT-ized content (3D model of the character) in the metaverse space.

For example, the metaverse control unit 403 converts the acquired 3D model of the character into a 3D model having a size specified by the size information. It should be noted that, in the metaverse space, the height of the user is often used as the height of the avatar, and the metaverse control unit 403 may determine the size of the character to be brought into the metaverse space using the ratio between the height of the user and the height (number of pixels) of the avatar, and convert it into a 3D model to be used in the metaverse space.

For example, in a case where the height of the user is 180 cm and the size information of the character is set to 180 cm, the metaverse control unit 403 may convert the NFT-ized 3D model into a 3D model having the same height as the avatar of the user (character used in the metaverse space).

In a case where a 3D model to be used in the metaverse space is obtained, the metaverse control unit 403 uses the 3D model in the usage form designated by the user.

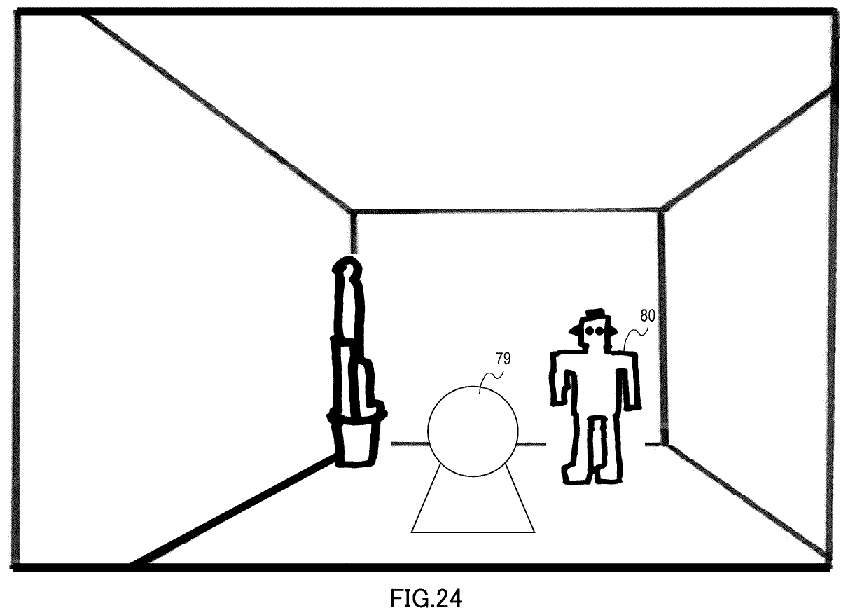

For example, in a case where the character purchased in the game is decorated in the user's own room as described above, the metaverse control unit 403 displays, on the terminal 70, a screen as shown in FIG. 24. In FIG. 24, a my room of the user is shown, an avatar 79 of the user is displayed, and a character 80 is placed in the room.

In this manner, the metaverse control unit 403 assigns a my room to a metaverse participant (a user who has logged into the metaverse server 60). The metaverse participant is able to use NFT content in the user's own room.

It should be noted that the metaverse control unit 403 may change a size and an arrangement of an NFT object in accordance with operations of the user or the like.

### Co-Creation Space

Here, the metaverse space realized by the metaverse control unit 403 is composed of a plurality of spaces including a my room (fields in which users act). A participant in the metaverse is able to move between the spaces and communicate with others.

Among the spaces constituting the metaverse space, there is a space provided by a host such as a metaverse business operator. The space is one in which any metaverse participant can participate.

In the following description, a space provided by a metaverse business operator in which any metaverse participant can participate is referred to as a “default space.”

A metaverse user (a user who has logged into the metaverse server 60) is able to create a community composed of a plurality of members. For example, classmates of a high school or a university may form one community as members, or users having the same hobby may form one community.

The metaverse control unit 403 provides a function of creating a community for the metaverse user. There are two types of communities in the metaverse space.

A first community is a community in which an unspecified number of users are not permitted to participate (act). The first community is a community in which only users selected by a host (a user who has established the community) can participate. The first community is referred to as a closed community.

A second community is a community in which an unspecified number of users can participate. The second community is a community in which the host examines applicants for participation and users who have passed the examination can participate. The second community is referred to as an open community.

In a case where a metaverse user performs a predetermined operation (for example, pressing a community generation button), the metaverse control unit 403 acquires a type of community (a closed community or an open community) that the user desires to generate.

In a case where the type of community is acquired, the metaverse control unit 403 selects a type of a space (a field) in which participants of the community act. For example, the user selects a type of space such as “island” or “town.”

In a case where the type of space in which participants of the community act is acquired, the metaverse control unit 403 acquires more detailed information related to the community from the user (the host). For example, the metaverse control unit 403 acquires a name of the community, an expected number of participants in the community, or the like.

For example, the metaverse control unit 403 acquires information such as a community type=closed, a type of space=island, a name of the community=“A university alumni association,” and an expected number of participants=50. Alternatively, the metaverse control unit 403 acquires information such as a community type=open, a type of space=town, a name of the community=“anime lovers association,” and an expected number of participants of the community=100.

In a case where the type of community and the expected number of participants are acquired, the metaverse control unit 403 generates, in the metaverse space, a space (a field) having an area corresponding to the expected number of participants. For example, the size (area) of a space allocated to a community with 100 expected participants is twice the size of a space allocated to a community with 50 expected participants.

For example, in the above example, the metaverse control unit 403 generates a space in which 50 users participating in the community “A university alumni association” act. Alternatively, the metaverse control unit 403 generates a space in which 100 users participating in the community “anime lovers association” act.

Members of each community can act in a space generated by the metaverse control unit 403. For example, members of the community “anime lovers association” can immediately meet other people who like anime by moving to the space of the community, and can enjoy conversations related to anime. That is, the metaverse user can easily meet others with the same hobby in a space allocated to the community. Since users with the same hobby are nearby, accidental conversations are likely to occur.

In addition, members of each community can edit (create or develop) a space allocated to their own community. For example, in a case where the type of space is “island,” members can create a forest by planting trees. Alternatively, in a case where the type of space is “town,” members can construct roads.

In this manner, members of the community cooperatively create one space. From this viewpoint, a space allocated to the community is referred to as a “co-creation space.” The metaverse control unit 403 generates, for each community to which at least one or more users belong, a co-creation space that can be edited by members belonging to the community.

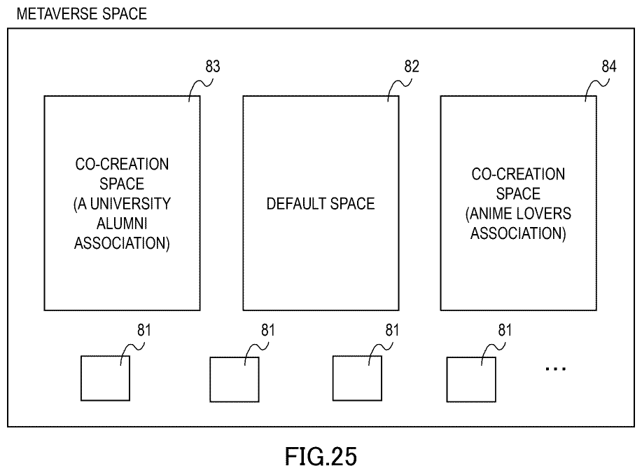

The concepts of the my room, the default space, and the co-creation space are illustrated in FIG. 25. As shown in FIG. 25, my rooms 81 of respective metaverse participants are generated in the metaverse space.

In addition, the metaverse control unit 403 generates a default space 82 in which any metaverse participant can participate (act). It should be noted that the default space does not have the concept that participants build up the space. In the default space, guidance or the like from a metaverse business operator is provided.

In addition, the metaverse control unit 403 generates co-creation spaces 83 and 84 corresponding to communities generated by users (for example, “A university alumni association,” “anime lovers association”). Only the members of the community are able to act in the co-creation space.

In a case where a co-creation space corresponding to a community is generated, the metaverse control unit 403 assigns an address to the generated co-creation space.

A host of a closed community notifies a user who wishes to participate in the community of a URL (Uniform Resource Locator) of the assigned address. For example, the host notifies other users of the URL by using an SNS (Social Networking Service) or email. A user who has obtained the URL for participating in the closed community can participate in the community by accessing the metaverse server 60 according to the URL.

The metaverse control unit 403 identifies a community in which the user participates based on the address accessed by the user. The metaverse control unit 403 stores an ID or the like of the user (the user who accessed the URL) in a database prepared for each community. By storing the ID in the database, the user is treated as a member (a participant) of the community.

It should be noted that in a case where the number of participants in the community exceeds the scheduled number of participants defined by the host, the metaverse control unit 403 may reject participation of a new user, or may expand the scheduled number of participants with the consent of the host.

A host of an open community recruits members to participate in the community. For example, the host posts, on a bulletin board installed in the default space, information about the host (such as a nickname of the host), information about the community (for example, a name of the community or the like), and a URL (a URL for participating in the community) embedded with the ID of the host.

In a case where a user who has viewed the bulletin board accesses the URL, the metaverse control unit 403 identifies the host based on the ID embedded in the URL, and connects the identified host and an applicant for participation in the community so that they can have a conversation (chat).

A host holds a conversation with an applicant for participation in an open community and determines whether to permit or reject the participation of the applicant in the community. The metaverse control unit 403 acquires a result determined by the host (permission of participation, rejection of participation).

In a case where the host permits participation, the metaverse control unit 403 stores an ID or the like of the permitted user in a database managing the community.

In addition, at the time of generation of a co-creation space or in a case where a new member participates in the community, the metaverse control unit 403 allocates, in the co-creation space, a place (a space) serving as an activity base of members (members of the co-creation space including the host). For example, the metaverse control unit 403 allocates, in the co-creation space, an area serving as a “house” of the user.

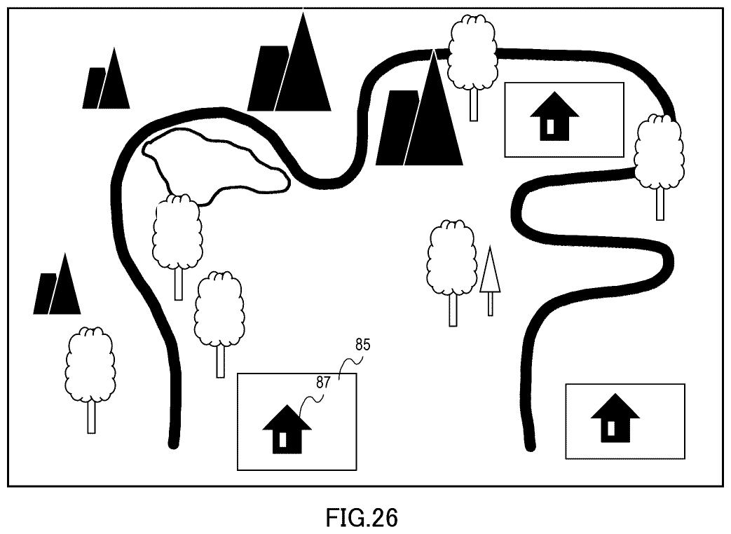

For example, in a case where a new member participates in a community in which “island” has been selected as a type of space, the metaverse control unit 403 allocates, as a house (a house including a yard) of the member, an area 85 shown in FIG. 26.

It should be noted that the metaverse control unit 403 may allocate a place in accordance with a request of a community participant, or may automatically select a vacant lot in the co-creation space and automatically allocate a “house” to the selected vacant lot.

For example, in a co-creation space of a town, residences of members are provided, and friends can establish their residences across a road. Alternatively, in a co-creation space of an island, a plurality of residential spaces are provided in one island, and each member sequentially occupies a desired residential space (each member selects a desired place as the residential space).

The metaverse control unit 403 arranges, in each of a plurality of co-creation spaces in which the user is a member, an appearance corresponding to the my room of the member. For example, as shown in FIG. 26, the metaverse control unit 403 arranges a home 87 having an appearance of a house corresponding to the my room of a community participant.

It should be noted that a metaverse user can belong to a plurality of communities. For example, one metaverse user can belong to a community composed of friends from university days, a community composed of colleagues at the workplace, a community composed of persons having the same hobby, or the like.

In a case where one metaverse user belongs to a plurality of communities, a “house” of the one metaverse user is allocated in each of co-creation spaces corresponding to the plurality of communities in which the user participates. In the above example, a my home having an appearance of a house is allocated to each of the co-creation spaces corresponding to a community composed of friends from university days, a community composed of colleagues at the workplace, and a community composed of persons having the same hobby.

The metaverse control unit 403 stores, by using a database managing each community, a location of a house (a my home) allocated to each user.

### Movement to Co-Creation Space

The metaverse control unit 403 enables a user in a my room to move from an exit (an entrance/exit) installed inside the my room to a co-creation space corresponding to the community to which the user belongs. Further, the metaverse control unit 403 enables an avatar of the user to move into the my room from an entrance (an entrance/exit) installed in an appearance (a my home) of the my room of the user.

Specifically, in a case where a user logs into an account of the metaverse server 60, the metaverse control unit 403 sets the inside of the my room of the user as a starting point of activity in the metaverse space. The metaverse control unit 403 displays the avatar of the user in the my room of the user.

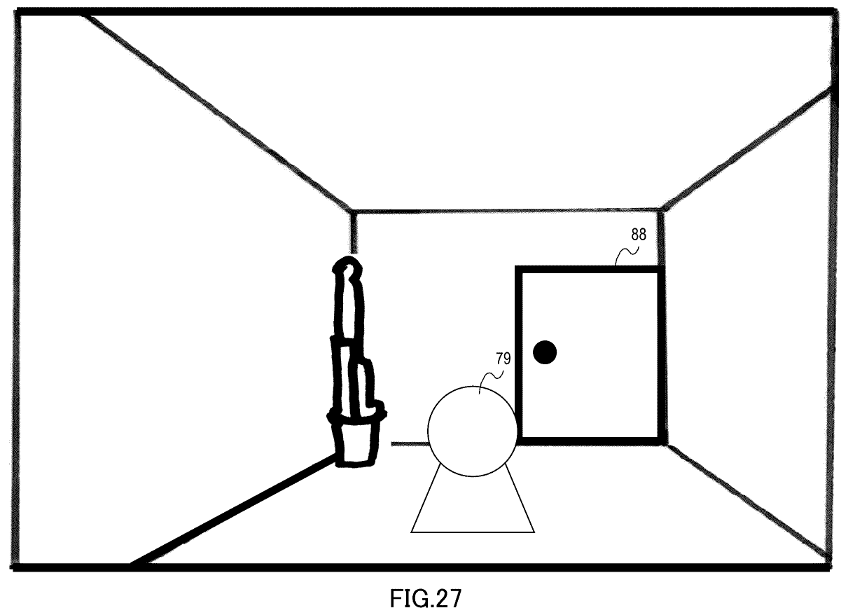

An exit for going out to the default space or the co-creation space is installed in the my room. For example, as shown in FIG. 27, a door 88 is installed in the my room.

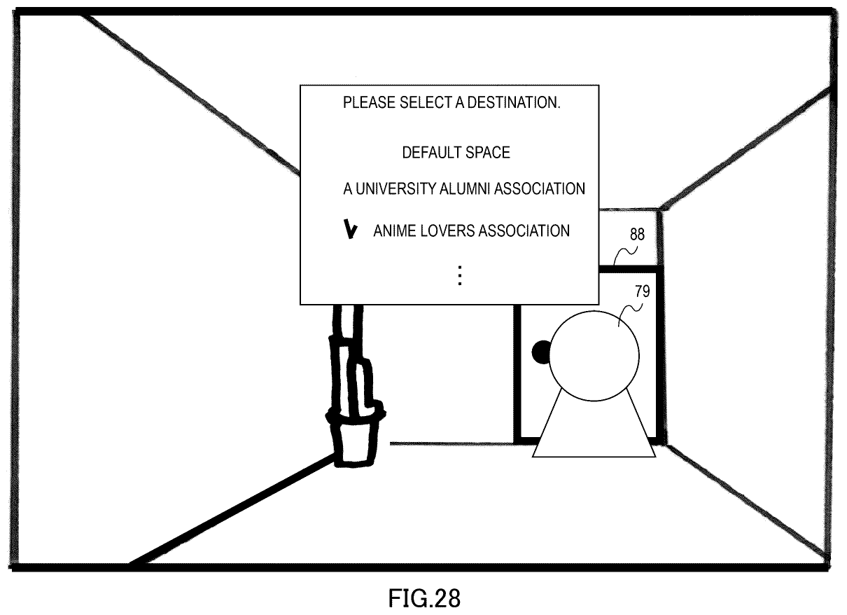

For example, in a case where the user (the avatar 79 of the user) moves to the front of the door 88, the metaverse control unit 403 acquires, by using a GUI as shown in FIG. 28, a space (a community) to which the user desires to move.

For example, in FIG. 28, in a case where the user selects “anime lovers association,” the metaverse control unit 403 moves the user (the avatar) to the co-creation space of the anime lovers community.

For example, in a case where the area 85 in FIG. 26 has been allocated to the user, the metaverse control unit 403 moves an avatar of the user to the area 85 (a garden of the user). Alternatively, in a case where a common facility (for example, a park or the like) exists in the co-creation space, the metaverse control unit 403 may move the user to the common facility.

### Activity in Co-Creation Space

A user (a community member) moves in the co-creation space and has a conversation with a person encountered. Alternatively, the user creates (edits) a garden of the user or a common facility or the like. For example, the user plants trees in the garden of the user. It should be noted that trees may be planted by default or buildings or the like may be installed in the garden or the common facility.

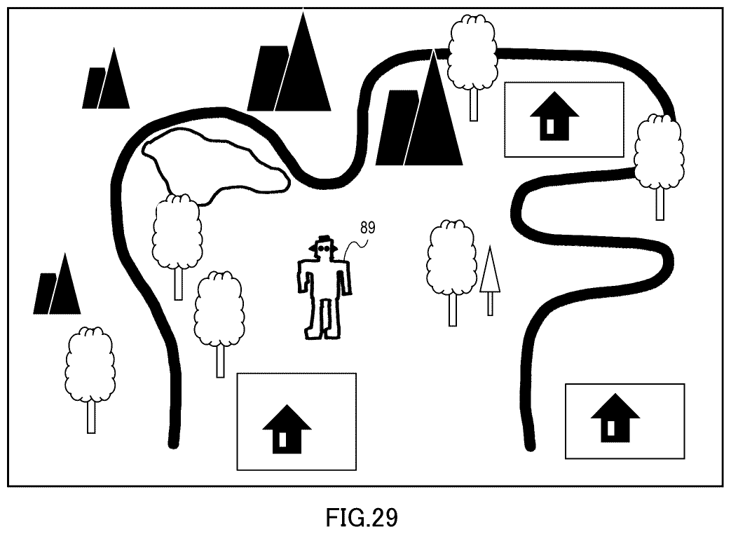

At that time, the user can arrange an NFT object in the co-creation space in the same manner as in the my room. For example, as shown in FIG. 29, the user can arrange a character 89 in the co-creation space.

It should be noted that the metaverse control unit 403 may display information of an NFT object placed in the co-creation space in the vicinity of the NFT object. For example, the metaverse control unit 403 may display tag information related to the character 89 (for example, a title of an animation in which the character 89 appears, a name of the character 89, or the like). That is, the metaverse control unit 403 may automatically reflect (display) tag information of the NFT object in the co-creation space.

### Movement from Co-Creation Space

In a case where activities in the co-creation space are completed, the user (the community member) exits from the co-creation space. For example, the user exits from the co-creation space being stayed in to move to a co-creation space of another community or the default space.

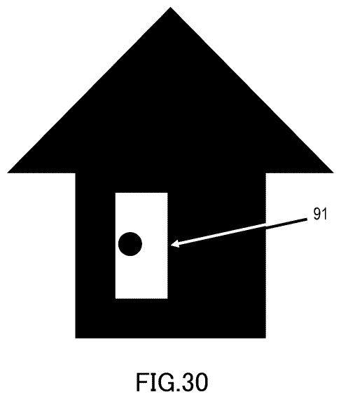

In this case, the user moves in front of the user's own my home (an appearance of the my room). In the my home, an entrance for entering the my room is provided. For example, as shown in FIG. 30, a door 91 is installed in each my home.

A user who wishes to exit from the co-creation space moves in front of a door installed in the my home. In a case where the metaverse control unit 403 detects that the user (an avatar of the user) has moved in front of the door of the my home, the metaverse control unit 403 moves the user into the my room.

A user who moves to another co-creation space or the like moves in front of an exit (the door 88 shown in FIG. 27) in the my room. The metaverse control unit 403 acquires, by using a GUI as shown in FIG. 28, a destination desired by the user.

As described above, the metaverse control unit 403 includes a function as a my room generation means and a function as a co-creation space control means. The my room generation means generates a my room for each user. The co-creation space control means generates, for each community to which the user belongs, a co-creation space editable by members belonging to the community. The co-creation space control means arranges an appearance of the my room in each of a plurality of co-creation spaces and enables an avatar of the user to move into the my room from an entrance installed in the appearance of the my room. Further, the co-creation space control means enables the avatar of the user in the my room to move from an exit installed inside the my room to a co-creation space corresponding to the community to which the user belongs.

As described above, an NFT object (an object that is NFT-ized and corresponds to content authorized by a right holder) may be arranged in the co-creation space. In this case, the metaverse control unit 403 may include a function as a display means for visibly displaying, to users staying in the co-creation space, information related to an owner of the NFT object. For example, the metaverse control unit 403 may display a nickname or the like of a user who arranged the NFT object in the vicinity of the NFT object.

Alternatively, the metaverse control unit 403 may limit the number of NFT objects that can be arranged in the co-creation space according to the number of members belonging to the community. For example, in a case where the number of metaverse users belonging to the community is 10, the metaverse control unit 403 allows 10 NFT objects to be arranged. Alternatively, in a case where the number of metaverse users belonging to the community is 100, the metaverse control unit 403 allows 100 NFT objects to be arranged.

Alternatively, the metaverse control unit 403 may hide NFT objects arranged in the co-creation space according to the number of members staying in the co-creation space. For example, in a case where the number of members staying in the co-creation space is five or less, the metaverse control unit 403 displays NFT objects arranged in the co-creation space. In contrast, in a case where the number of members staying in the co-creation space is more than five, the metaverse control unit 403 hides NFT objects arranged in the co-creation space.

### Disclosure of Co-Creation Space

As described above, only members of a community can visit a co-creation space. However, by intention of a host or the like, the co-creation space may be disclosed to an unspecified number of users. Specifically, the metaverse control unit 403 generates, in the metaverse space, a duplicate of a co-creation space designated by the host in accordance with an instruction from the host (a specific operation by the host) or the like.

For example, in a case where a host of an anime lovers community desires disclosure of the co-creation space of the community, the metaverse control unit 403 generates, in the metaverse space, a duplicate of the co-creation space corresponding to the anime lovers community.

It should be noted that, in the following description, a duplicate of a co-creation space is referred to as a “duplicate space.” In the duplicate space, a my home of each member and NFT objects or the like arranged by each member are similarly arranged.

A user who is not a member of the community moves from a default space provided by the metaverse server 60 to the duplicate space. For example, the metaverse control unit 403 provides, in the default space, a spot for moving to the duplicate space together with guidance of the community corresponding to the duplicate space. A user (an avatar) who desires to move to the duplicate space gets on the spot.

The metaverse control unit 403 moves the user who has gotten on the spot to the duplicate space.

A user (an avatar) can move in the duplicate space and have a conversation with a person encountered, in the same manner as in the co-creation space. In addition, the user can view NFT objects arranged in the duplicate space. However, a user who has visited the duplicate space cannot perform editing work (for example, arranging a character NFT object) in the space.

In this manner, the metaverse control unit 403 includes a function as a duplicate space control means for generating a duplicate space which is a duplicate of a co-creation space and which can be visited by users other than members of the corresponding community.

### Comments in Co-Creation Space

The metaverse control unit 403 may include a function enabling a user (a community member) who has visited a co-creation space to leave a comment on an object arranged in the co-creation space, particularly on an NFT object. More specifically, the metaverse control unit 403 includes a function of storing, in association, a current position of the visiting user in the co-creation space and a comment of the user.

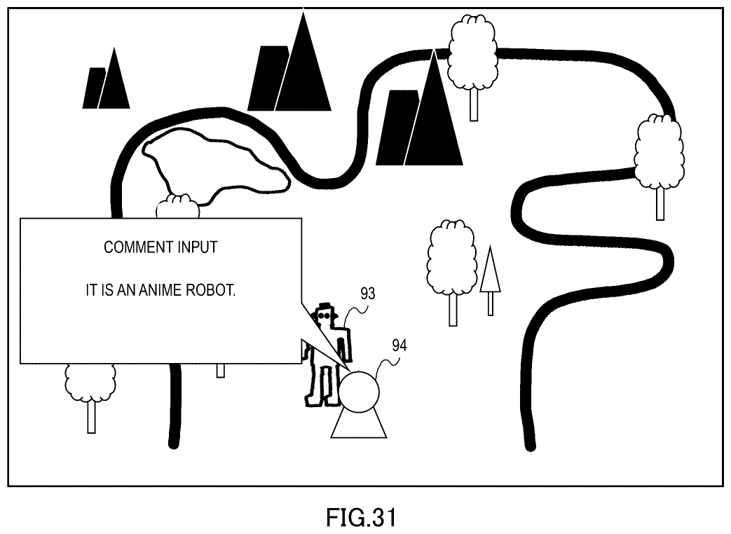

For example, in FIG. 31, a user 94 can leave a comment in the vicinity of a character 93. For example, in a case where the user 94 approaches a vicinity of the character 93 (a predetermined range centered on the position of the character 93), the metaverse control unit 403 acquires, by using a GUI or the like, whether the user 94 wishes to leave a comment on the character 93 or to browse comments of others.

In a case where the user 94 wishes to leave a comment, the metaverse control unit 403 displays a signboard (a virtual signboard) for inputting the comment.

The user 94 inputs a comment by voice or handwriting. In this case, the metaverse control unit 403 manages the comment left by the user 94 as a comment on the character 93.

Specifically, the metaverse control unit 403 stores various information in a database that manages comments on NFT objects. For example, the metaverse control unit 403 manages and stores information of an owner of the NFT object, a position of the NFT object, information of a user who commented on the NFT object (for example, an ID), contents of the comment, or the like.

More specifically, the metaverse control unit 403 stores, in association with the comment, in the database a position in a 3D space (the co-creation space generated in the metaverse space) of a user (a first user) at the time of commenting and a date and time at which the comment was made.

In a case where a user who has moved to the vicinity of an NFT object wishes to browse comments of others, the metaverse control unit 403 accesses the database managing comments on the NFT object and displays comments stored for the corresponding NFT object.

Specifically, in a case where the metaverse control unit 403 accepts a comment display request from a user (a second user) in the 3D space, the metaverse control unit 403 selects at least one comment from among a plurality of comments stored in the database. More specifically, the metaverse control unit 403 selects at least one comment from among the plurality of stored comments based at least on positions associated with the stored comments and a position in the 3D space of the user who made the comment display request.

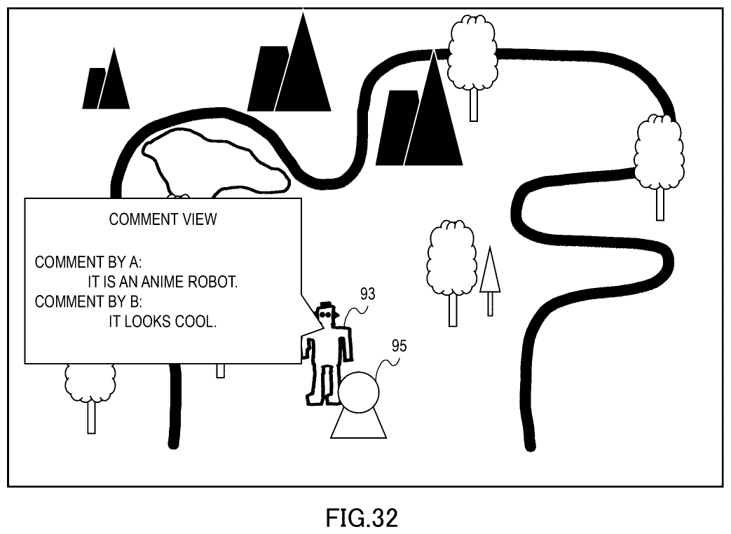

For example, as shown in FIG. 32, in a case where a user 95 wishes to browse comments in the vicinity of the character 93, the metaverse control unit 403 selects, from among the plurality of comments, a comment associated with a position substantially identical to the position of the user 95.

The metaverse control unit 403 displays the selected at least one comment so that the user can visually recognize it. For example, in the examples of FIGS. 31 and 32, comments including a comment of the user 94 are presented to the user 95.

A user (a community member) who has visited the co-creation space can know what impressions others had about an object (an NFT object) near the user.

In this manner, the metaverse control unit 403 includes functions as a comment receiving means, a display-request receiving means, a comment selecting means, and a display control means. The comment receiving means accepts a comment from a first user who uses a 3D space (the metaverse space or the co-creation space). The display-request receiving means receives a comment display request from a second user in the 3D space The comment selecting means selects at least one comment from among the plurality of stored comments based at least on positions associated with the stored comments and a position in the 3D space of the second user who made the comment display request. The display control means displays the selected at least one comment so that the second user can visually recognize it. It should be noted that the position in the 3D space of the first user at the time of commenting and the date and time at which the comment was made are stored in the database (the storage unit 404) in association with the comment.

Furthermore, the metaverse control unit 403 may select a comment to be presented to the above-described second user based on a date and time at which the comment was left. For example, the metaverse control unit 403 may preferentially display newer comments. That is, the metaverse control unit 403 may select at least one comment from among the plurality of stored comments based on the positions and dates/times associated with the stored comments and a position of the second user in the 3D space.

In a case where comments by a plurality of users have been left on one NFT object, the metaverse control unit 403 may display the commenters in a manner identifiable to a viewer of the comments. The metaverse control unit 403 may enable a viewer of the comments to identify comments by other users.

For example, the metaverse control unit 403 may enclose and display a comment of one user, or may display comments in different colors for different users. Alternatively, in a case where a user leaves a comment, the metaverse control unit 403 may automatically assign a color to each user and store the comment acquired from the user in association with the assigned color.

### Tipping Function

The metaverse control unit 403 may include a mechanism (a tipping function) by which a comment poster gives money to a host of the co-creation space, an owner of an NFT object, or a right holder of the NFT object.

For example, the metaverse control unit 403 displays a “tipping button” in a GUI in a case where a comment is acquired from a user. In a case where the tipping button is pressed, the metaverse control unit 403 acquires an amount of a tip from the user (the comment poster). The metaverse control unit 403 transfers the acquired amount from a wallet (a virtual currency wallet) of the tipping user to a wallet of the community host.

Alternatively, a tip given in the co-creation space may be paid to an owner of the NFT object or a right holder (an author) of the NFT object instead of or in addition to the community host. In this case, the metaverse control unit 403 transfers, to wallets of the community host, the owner of the NFT object, the right holder of the NFT object, or the like, amounts apportioned at predetermined ratios. It should be noted that a wallet of the right holder of the NFT object may be set in accompanying information of the NFT content or may be set in the corresponding NFT.

Alternatively, a distribution ratio of tips may be automatically determined by the metaverse control unit 403. For example, the metaverse control unit 403 may determine the distribution ratio by using a learning model obtained by machine learning. For example, the metaverse control unit 403 inputs a comment with a tip to the learning model and obtains an evaluation of the comment (for example, three grades of evaluation such as good, bad, and average). The metaverse control unit 403 determines the distribution ratio based on the obtained evaluation of the comment. For example, in a case where an evaluation of a comment is high, the metaverse control unit 403 determines a distribution ratio so that a larger amount of tips is distributed to a right holder.

Alternatively, the metaverse control unit 403 may allow a comment poster to determine a distribution ratio in a case of distributing tips. For example, the metaverse control unit 403 may propose a distribution ratio to the comment poster and allow the comment poster to arrange the proposed distribution ratio within a predetermined range.

The metaverse control unit 403 stores, in a database that manages comments, an ID of a user who tipped, a comment, or the like in association with an amount of the tip. The metaverse control unit 403 may also write a comment made on the NFT object into metadata of the NFT. The metaverse control unit 403 may store, in metadata of the NFT object, a date and time at which the comment was left, a user name of the commenter, an amount, contents of the comment, or the like.

It should be noted that tipping may be performed not only in the co-creation space but also in the duplicate space. In this case, the metaverse control unit 403 may distribute a tip made in the duplicate space to an owner of the NFT object, a right holder, or the like.

The metaverse control unit 403 may preferentially display comments accompanied by tips in a case of displaying comments left on an NFT object. Alternatively, among comments accompanied by tips, the metaverse control unit 403 may preferentially display comments accompanied by larger amounts of tips.

For example, the metaverse control unit 403 prevents comments accompanied by tips from being overwritten by other comments, or slows overwriting by other comments. Alternatively, the metaverse control unit 403 may provide preferential treatment such as prioritizing the display order of comments with tips, displaying them in the foreground, or displaying them in larger characters, or the like.

In this manner, the metaverse control unit 403 may accept a comment and money from a third user who uses the 3D space. In this case, a position of the third user in the 3D space, a date and time at which the comment was made, and an amount of the accepted money are stored in the database (the storage unit 404) in association with the comment. The metaverse control unit 403 may select at least one comment from among the plurality of stored comments based on positions associated with the stored comments, a position in the 3D space of a second user who made a comment display request, and an amount of money. Furthermore, the metaverse control unit 403 may display the one or more selected comments in an order based on amounts of money (amounts of tips obtained) given together with each comment.

In addition, the metaverse control unit 403 may include a function as a distribution means. In a case where an NFT object is arranged in the 3D space, the metaverse control unit 403 may distribute, to a right holder at a predetermined distribution ratio, money (a tip) accepted together with comments made within a predetermined range from an arrangement position of the object in the 3D space.

The metaverse control unit 403 may define, for each NFT object arranged in the co-creation space, criteria for displaying comments made on the NFT. For example, the metaverse control unit 403 displays comments on a character A by prioritizing newer comments. Alternatively, the metaverse control unit 403 displays comments on a character B by prioritizing comments with larger amounts of tips.

In this manner, the metaverse control unit 403 may display, in a visually recognizable manner to the second user, one or more comments selected according to a priority of criteria based on a position of a user who wishes to browse comments (a position of the NFT object).

The metaverse control unit 403 may display only comments of commenters related to a user who wishes to browse comments. For example, the metaverse control unit 403 may display only comments of users whom the browsing user follows or is followed by on an SNS (Social Networking Service). Alternatively, the metaverse control unit 403 may preferentially display comments of users related to the comment viewer.

The metaverse control unit 403 may identify a target NFT object based on a direction of a gaze of the user (the avatar) in a case of acquiring or displaying a comment. For example, in a case where two characters are arranged in proximity to each other and the user looks at the character on the right, the metaverse control unit 403 determines that the user wishes to leave or browse a comment on the character on the right.

In this manner, the metaverse control unit 403 may use not only the position of the user but also a direction in which the user is looking both at a time of comment registration (comment acquisition) and at a time of display. That is, a direction in the co-creation space of the first user at a time of commenting is stored in the database in association with the comment. The metaverse control unit 403 selects at least one comment from among the plurality of stored comments based on positions, dates/times, and directions associated with the stored comments and a position and a direction of the second user in the co-creation space.

It should be noted that a detailed description related to realization of basic functions of the metaverse space (the metaverse platform) by the metaverse control unit 403 (for example, movement of avatars, conversations between avatars, or the like) will be omitted. This is because realization of such functions is apparent to those skilled in the art and differs from the gist of the present disclosure.

The storage unit 404 is means for storing information necessary for operation of the metaverse server 60. For example, the storage unit 404 stores information related to comments on NFT objects by using a predetermined database.

### Service Server

Detailed description related to configuration and operation related to the service server 10 will be omitted. After selling a product to the user, the service server 10-1 may store the purchase history of the sold product. Alternatively, the service server 10-2 may store a play history related to a game of the user (a play history including a purchase history related to characters, items, or the like).

### Wallet Server

A detailed description of the configuration and operation of the wallet server 50 will be omitted. The wallet server 50 may issue a wallet address to the user.

### Content Management Server

A detailed description of the configuration and operation of the content management server 30 will be omitted. The content management server 30 stores the digital content for each product handled by own company and its accompanying information, and may transmit the digital content and the accompanying information in accordance with a request from the NFT management server 40.

More specifically, if no digital content or the like corresponding to the product code included in the content providing request exists, the content management server 30 transmits to the NFT management server 40 a negative response indicating that fact. In a case where digital content or the like of a product code included in the content providing request exists, the content management server 30 transmits to the NFT management server 40 a positive response indicating the fact, the positive response including the digital content and accompanying information thereof.

It should be noted that a figure manufacturer or the like registers in advance, in the content management server 30, the product codes, digital content, and accompanying information related to its own products.

### Terminal

Examples of the terminal 70 include a portable terminal device such as smartphones, HMDs, mobile phones, game machines, and tablets, and also computers (personal computers and notebook computers). The terminal 70 can be any apparatus or device insofar as it accepts user operations and is capable of communicating with the integrated management server 20 or the like. Further, since the configuration, and so on, of the terminal 70 is obvious to those skilled in the art, a detailed description will be omitted.

### System Operation

Next, operations of the information processing system according to the first example embodiment will be described.

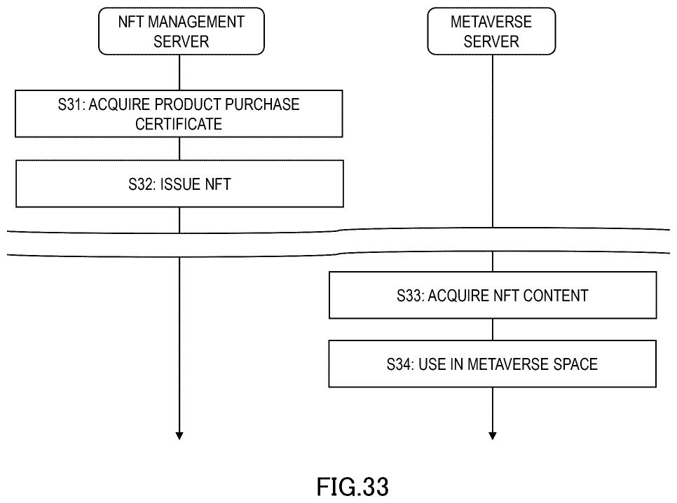

FIG. 33 is a sequence diagram illustrating an example of the operations of the information processing system according to the example embodiment disclosed in the present application. With reference to FIG. 33, the operations of the information processing system according to the first example embodiment will be described.

In a case where a user desires the issuance of a product purchase certificate, the NFT management server 40 acquires the product purchase certificate from the wallet of the user (step S31).

Furthermore, the NFT management server 40 acquires the digital content and the accompanying information of the product corresponding to the product purchase certificate that the user desires to issue from the content management server 30, and issues an NFT corresponding to the acquired digital content (step S32).

In a case where the user desires to use NFT content in the metaverse space, the metaverse server 60 acquires the NFT content and the accompanying information from the NFT management server 40 (step S33).

The metaverse server 60 uses the NFT content in the metaverse space by using the acquired NFT content and the accompanying information (step S34).

Next, variations according to the first example embodiment will be described.

### Variation 1

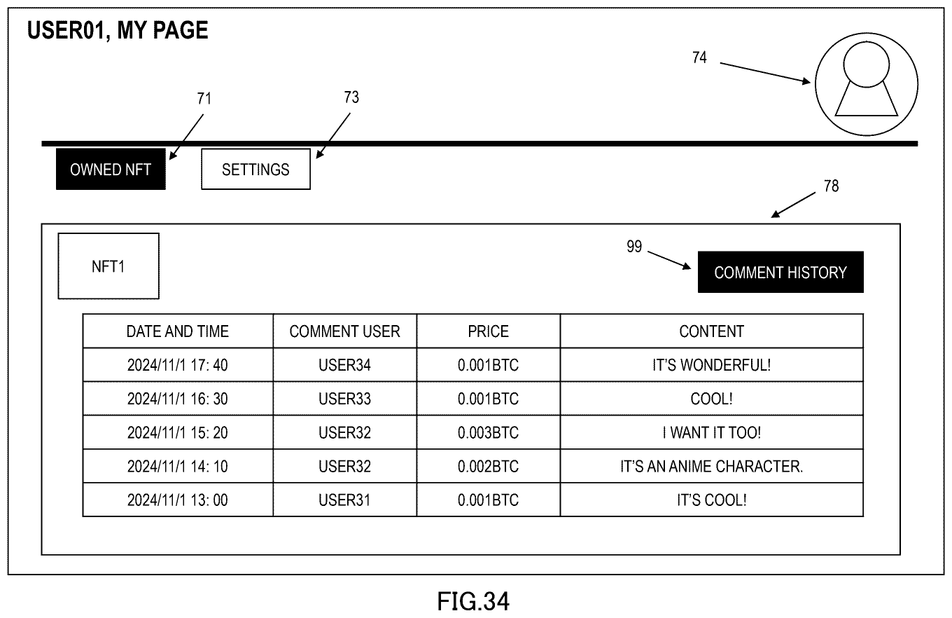

The NFT management server 40 may display a history related to chats performed with respect to NFT content, in particular, a history related to comments accompanied by tipping. In this case, the my page control unit 305 may display a history related to comments associated with the NFT selected by the user in response to a comment history button 99 being pressed, as shown in FIG. 34.

As described above, comments made by users of the metaverse space with respect to the NFT that is placed in the metaverse space are set for the NFT, and the my page control unit 305 may display comments on the NFT separately from a transaction history related to the NFT. In particular, the my page control unit 305 may display a history related to comments with tipping that occurred within a predetermined range from an installation position of an NFT object placed in the metaverse space.

### Variation 2

The NFT management server 40 may include a function for updating tags (hashtags) set for the NFT. In this case, the NFT management server 40 performs account linkage with the service server 10-2 (a game server). The my page control unit 305 of the NFT management server 40 periodically logs in to the server using login information of the game server.

Among NFTs owned by the user, in a case where there exists an NFT originating from a game provided by the game server, the my page control unit 305 acquires information such as character information corresponding to the NFT (acquired from a play history or the like accumulated in the account of the game server). The my page control unit 305 updates tags displayed on the my page and the like, in a case where there exists a tag among tags set for the NFT that can be updated from a play history or the like (information corresponding to the tag).

For example, in a case where the strength (level) of a character set for the NFT is not at the maximum before accessing the game server but reaches the maximum as the game progresses, the my page control unit 305 updates a tag related to the strength of the NFT to “#Level MAX.”

Alternatively, the my page control unit 305 may allow the user to view a setting date and time and an update date and time for each tag. That is, the user is able to know the date and time at which a tag was set or updated. Alternatively, the my page control unit 305 may allow the user to select tags to be displayed for the NFT in a case where the user sells (lists) the NFT.

### Variation 3

The my page control unit 305 may set (add) a tag to an NFT in accordance with a transaction market price related to NFTs of the same type as an NFT owned by the user (an average value of transaction prices of a plurality of NFTs). For example, in a case where the average value of transaction prices of a game character A is 1000 yen, the my page control unit 305 sets a tag such as “#Transaction Market Price 1000 yen” for the corresponding NFT. Alternatively, in a case where the transaction price of the NFT updates a high price, the my page control unit 305 may automatically display the updated price (transaction price) as a tag.

### Variation 4

In accordance with utilization of NFT content in a metaverse space, a title may be set for the NFT. For example, a condition for granting a title may be set such that the NFT is utilized in an event held in the metaverse space. For example, in the metaverse space, in a case where an event related to an IP (a game) to which the NFT belongs is held, and the number of participants of the event is equal to or greater than a predetermined number, and NFT content (a 3D model of a character) is placed in an event venue, it is determined that the condition is satisfied.

In this case, NFT content placed in the event venue is determined to have contributed to promotion of a game or the like, and a predetermined title is granted. The granted title may be displayed as a tag on the my page or the like. For example, a tag such as “#Event Contribution” is displayed on the my page or on a transaction history screen.

### Variation 5

For an NFT (metadata of the NFT), information related to a metaverse space (a metaverse platform) in which content corresponding to the NFT can be used may be set. For example, information may be set such that NFT1 is available in metaverse space 1 and metaverse space 2, and NFT2 is available in metaverse space 2 and metaverse space 3. The information may be set in advance by an IP holder.

The my page control unit 305 may display, as a tag, information related to a metaverse space in which content corresponding to the NFT can be used. For example, the my page control unit 305 may display a tag such as “#Compatible with Metaverse Space 1 and Metaverse Space 2” on the my page or on a transaction history screen.

### Variation 6

For an NFT, information related to a metaverse space in which the NFT has been used may be set. For example, in a case where NFT1, which is available in metaverse space 1 and metaverse space 2, is used in metaverse space 1, the fact is set in the NFT (metadata of the NFT).

The my page control unit 305 may display, on the my page or the like, information related to usage tendencies of a metaverse space of the user, based on a record that an NFT owned by the user has been used in the metaverse space.

For example, the my page control unit 305 displays, in the vicinity of the icon display area 74, a name or the like of the metaverse space most frequently used by the user (the metaverse space in which the NFT content is most frequently used). Alternatively, the my page control unit 305 may display, on the my page, a name or the like of the metaverse space in which the NFT content was most recently utilized.

### Variation 7

The metaverse server 60 and the NFT management server 40 may be linked with each other in terms of accounts. In this case, the my page control unit 305 may access the metaverse server 60 and acquire an ID or the like of a user who has been set as a friend in the metaverse space. The my page control unit 305 may search a database by using the acquired ID and identify a user (a user of the NFT platform) corresponding to the acquired ID.

The my page control unit 305 may display, on the my page or on a transaction history screen, information related to other users who are set as friends in the metaverse space.

Alternatively, the my page control unit 305 may provide an interface for searching other users who are set as friends in the metaverse space. For example, in a case where a user name used in the metaverse space is input, the my page control unit 305 may display a my page or the like of an NFT platform user corresponding to the user name. The user can check a list of NFTs owned by a user who is set as a friend in the metaverse space.

Alternatively, the my page control unit 305 may propose that a user who is set as a friend in the metaverse space be also set as a friend in the NFT platform.

The metaverse server 60 may display, in the metaverse space, a friend set as a friend in the NFT platform in a manner identifiable. Alternatively, the metaverse server 60 may provide an interface enabling a search for friends in the NFT platform in the metaverse space.

### Variation 8

The metaverse server 60 may allow a user who has visited a duplicate space to leave a comment on an object (an NFT object). At that time, the metaverse control unit 403 may enable a user (a member of the community) to view, in the corresponding co-creation space, a comment made in the duplicate space. At that time, the metaverse control unit 403 may display comments made in the duplicate space and comments made in the co-creation space (the main space) in a manner that allows a comment viewer to distinguish between them.

The metaverse control unit 403 controls not only ordinary comments but also comments accompanied with tipping so that visitors can view them in both the co-creation space and the duplicate space.

In this case, the metaverse control unit 403 may store, in a database for managing comments, each comment while distinguishing whether the comment has been made in the duplicate space or in the co-creation space.

### Variation 9

The metaverse server 60 may allow an administrator (a community organizer) or a right holder of an NFT object to verify validity related to content of a comment before the comment left in a co-creation space or a duplicate space is published.

In this case, when a comment is registered for an NFT object, the metaverse control unit 403 transmits the registered comment to an organizer of the co-creation space or the like. The organizer verifies the comment and replies the verification result (the comment is appropriate or inappropriate) to the metaverse server 60. The metaverse control unit 403 deletes a comment judged to be inappropriate and does not store it. Alternatively, the metaverse control unit 403 sets a comment judged to be inappropriate as unviewable.

Alternatively, in a case where the organizer determines that a comment is extremely malicious, the organizer notifies the metaverse server 60 to that effect. The metaverse control unit 403 expels a user who left the malicious comment from the community in a case where the user is a community member. Alternatively, the metaverse control unit 403 prohibits the user who left the malicious comment from entering the duplicate space again.

Verification related to the comment may be automatically performed by the metaverse server 60. For example, the metaverse control unit 403 may determine whether or not a comment is appropriate by using an LLM (Large Language Model). Alternatively, upon receiving a report from a user who viewed a comment, the metaverse control unit 403 may request the organizer to verify the comment or may automatically verify it.

Alternatively, the metaverse control unit 403 may store the number of times an inappropriate comment has been left for each user and expel a user from the co-creation space or prohibit entry in a case where the number reaches a predetermined value.

Alternatively, in a case where the metaverse server 60 verifies comments, the criteria for determining appropriateness of comments may differ between the co-creation space and the duplicate space. Specifically, the metaverse control unit 403 may judge a comment to be inappropriate in the co-creation space (the community) even though the comment is judged to be appropriate in the duplicate space. For example, the metaverse control unit 403 may perform the above determination by using different LLMs in the co-creation space and the duplicate space, or may perform the above determination by changing a prompt input to the LLM.

### Variation 10

The metaverse server 60 may include a function for integrating a plurality of communities into one community. For example, in accordance with an application from organizers of respective communities, the metaverse control unit 403 may integrate a plurality of communities into one community.

In this case, the metaverse control unit 403 may connect corresponding co-creation spaces or may regenerate a co-creation space having a size corresponding to the number of participants of a new community.

### Variation 11

The metaverse server 60 may include a function that allows searching for communities in a default space. For example, the metaverse control unit 403 may realize a search using information related to NFT objects installed in co-creation spaces corresponding to respective communities.

For example, in a case where a user wishes to know a co-creation space (a corresponding community) in which a character A of a game A is installed, the user may input “Game A, Character A” into a search window provided by the metaverse control unit 403.

The metaverse control unit 403 may refer to NFTs and accompanying information of NFT objects installed in respective co-creation spaces and present, as a search result, a co-creation space (a community) in which the above character is installed.

### Variation 12

An organizer of a community may set, as a participation condition, that an applicant wishing to participate in the community owns specific NFT content. In this case, the organizer informs the applicant of the above participation condition in examining the applicant who wishes to participate in the community. The applicant specifies a requested NFT content from among NFT contents owned by the applicant. The metaverse control unit 403 acquires the specified NFT content and accompanying information from the NFT management server 40 and presents them to the organizer.

### Variation 13

In a co-creation space, NFT content owned by members (sound source data or video data corresponding to CDs, DVDs, or the like) may be capable of being played back. At that time, the number of people who can simultaneously view the NFT content may be set in the NFT of the NFT content or accompanying information.

The metaverse control unit 403 plays back NFT content in a case where the number of viewers is smaller than the set number. Alternatively, the metaverse control unit 403 allows NFT content to be played back in a case where the number of participating members of a community is smaller than the number of viewable persons set for the NFT content. For example, the metaverse control unit 403 executes control such that NFT content viewable by four or fewer people cannot be brought into a co-creation space accessible by five or more people.

### Variation 14

A community and its co-creation space may have a sub-administrator set. For example, an organizer (administrator) of a community may appoint a sub-administrator. The metaverse control unit 403 may request the sub-administrator to examine applicants wishing to participate in the community in a case where the organizer is absent from the co-creation space.

### Variation 15

The metaverse control unit 403 may display, in a window through which the outside can be seen from inside a my room, a scenery of a co-creation space set by a user. Alternatively, the metaverse control unit 403 may display, in the window, a scenery of a co-creation space most recently visited by the user.

### Variation 16

In a co-creation space or a duplicate space, advertisements by companies or the like may be carried out. Revenue from the advertisements may be distributed to organizers of the community, right holders of NFT objects, or the like.

### Variation 17

In the above example embodiment, operations of the information processing system and the like have been described by taking a game as an example of a service provided using a 3D model. However, a service using a 3D model is not limited to a game. For example, provision of a metaverse space is also included in services using a 3D model.

In other words, NFT content such as a product purchased by a user in a metaverse space may be sold to the user. That is, the service server 10 may include the function of the metaverse server 60, or the metaverse server 60 may include the function of the service server 10.

More specifically, NFT content (3D model) of a product purchased in a first metaverse space may be used in a second metaverse space.

In addition, a target of content to be converted into an NFT is not limited to a character in a game or metaverse, but may be an item such as a weapon used in a game, or may be a building or the like appearing in the metaverse.

### Variation 18

NFT content (3D model) targeting a character obtained by a user through a paid lottery (so-called gacha) in a game may be sold.

Alternatively, in a case where the appearance of a character (so-called skin) is sold in a game, a 3D model of a character having the appearance of the sold skin may be sold as NFT content.

### Variation 19

A product corresponding to NFT content that can be purchased by a user may be a character, an item, or the like acquired by the user free of charge in a game. In this case, the integrated management server 20 may request the user to pay a certificate issuance fee in a case where a product purchase certificate for the character or the like acquired free of charge is issued.

Alternatively, the NFT management server 40 may request the user to pay an NFT issuance fee in the case of selling NFT content corresponding to a character or the like acquired free of charge by the user.

Alternatively, NFT content may be sold (transferred) completely free of charge to a user for some characters or the like. That is, the integrated management server 20 does not require the user to pay a certificate issuance fee for a product purchase certificate, and the NFT management server 40 does not require the user to pay an NFT issuance fee, and NFT content may be sold to the user free of charge (without charge).

### Variation 20

Even in a case where there is no application from a user, all or a part of a product purchased by a product purchaser may be automatically distributed as NFT content to the product purchaser. That is, NFT content may be distributed free of charge to the user without the user making a request to the integrated management server 20 for issuance of a product purchase certificate.

In this case, the metaverse server 60 may use NFT content purchased by the user and NFT content distributed free of charge without distinction in the metaverse space. In a case where NFT content is distributed free of charge, the metaverse server 60 may periodically or at predetermined timings access the wallet of the user to determine whether or not there is newly distributed NFT content. In a case where there is newly distributed NFT content, the metaverse server 60 may inquire of the user regarding whether or not the NFT content can be used.

### Variation 21

In the above example embodiment, the integrated management server 20 has been described in connection with a case where the integrated management server 20 acquires a purchase history of a product and a play history of a game by logging into a service server 10 linked with an account. However, the integrated management server 20 may acquire the purchase history and the play history from the service server 10 without linking the account. For example, the service server 10 transmits information of the purchased product and a wallet address of the user to the integrated management server 20 in a case where the user purchases the product. The integrated management server 20 may identify the user using the received wallet address and store the purchase history in the account of the identified user.

### Variation 22

In the above example embodiment, the integrated management server 20 has been described in connection with a case where the integrated management server 20 issues a product purchase certificate in accordance with a request from the user. However, the integrated management server 20 may issue the product purchase certificate in accordance with having acquired the purchase history of the product from the service server 10. That is, a purchase certificate control unit 203 of the integrated management server 20 may automatically issue the product purchase certificate.

### Variation 23

In the above example embodiment, the integrated management server 20 has been described in connection with a case where the integrated management server 20 issues a product purchase certificate as an SBT. However, the integrated management server 20 may issue a product purchase certificate in another format.

Specifically, the purchase certificate control unit 203 of the integrated management server 20 may issue a digital certificate using a Public Key Infrastructure (PKI) as the product purchase certificate. Alternatively, the purchase certificate control unit 203 may issue a credential certificate (VCs; Verifiable Credentials), whose content can be verified online, as the product purchase certificate.

In a case where the digital certificate or the credential certificate is issued as the product purchase certificate, the NFT management server 40 verifies an electronic signature appended to these certificates. If the verification of the electronic signature is successful, the NFT management server 40 issues the NFT of the NFT content.

In addition, in a case where the digital certificate using the PKI or the credential certificate is issued as the product purchase certificate, these certificates may be managed by the wallet of the user, or may be managed in an account of the integrated management server 20 or the NFT management server 40.

In a case where the integrated management server 20 manages the product purchase certificate of the user, the NFT management server 40 requests the integrated management server 20 to provide the product purchase certificate. Specifically, the sales control unit 303 of the NFT management server 40 transmits a wallet address of the user to the integrated management server 20. The integrated management server 20 identifies the user who wishes to purchase the NFT content using the wallet address and transmits the product purchase certificate stored in the account of the identified user to the NFT management server 40.

In a case where the NFT management server 40 manages the product purchase certificate of the user, the purchase certificate control unit 203 of the integrated management server 20 transmits the issued product purchase certificate together with the wallet address of the user to the NFT management server 40. The user management unit 202 of the NFT management server 40 identifies the user who has received the issuance of the product purchase certificate using the wallet address and stores the received product purchase certificate in the account of the identified user.

### Variation 24

A system configuration shown in FIG. 3 is an example. For example, the integrated management server 20 operated by a platform business operator may provide a wallet service. That is, the integrated management server 20 may include a function of a wallet server 50.

Alternatively, in the above example embodiment, the NFT management server 40 has been described in connection with a case where the NFT management server 40 issues an NFT of NFT content. However, the integrated management server 20 may issue the NFT of the NFT content. That is, the integrated management server 20 may include a function of the NFT management server 40.

As described above, the NFT management server 40, which is an NFT management apparatus, acquires an NFT issued in accordance with the fact that the user has purchased a product. The NFT management server 40 displays information related to the acquired NFT. For example, the NFT management server 40 displays a purchase history of a product serving as a basis of the NFT issuance as a part of a transaction history of the NFT. Alternatively, the NFT management server 40 displays a tag set for the NFT. As a result, a user can easily manage NFTs owned by the user. That is, convenience of a user who owns an NFT issued by a purchase of a product is improved.

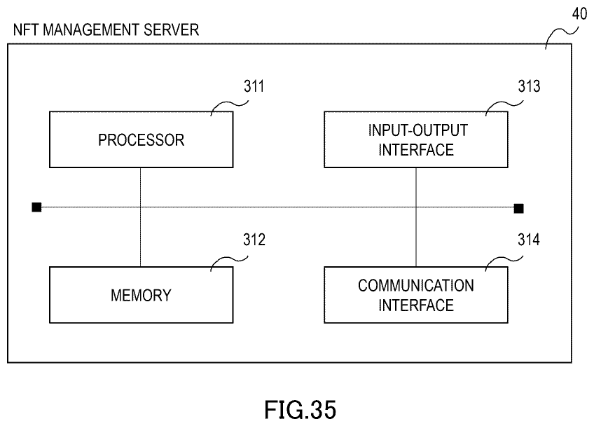

Next, a hardware configuration of an individual apparatus that constitutes the information processing system will be described. FIG. 35 is a diagram illustrating an example of a hardware configuration of the NFT management server 40.

The NFT management server 40 can be configured by an information processing apparatus (a so-called computer) and has a configuration illustrated as an example in FIG. 35. For example, the NFT management server 40 includes a processor 311, a memory 312, an input-output interface 313, a communication interface 314, and so on. The above-described components such as the processor 311 are connected via an internal bus or the like and are configured to be capable of communicating with each other.

However, the configuration shown in FIG. 35 is not intended to limit the hardware configuration of the NFT management server 40. The NFT management server 40 may include hardware not illustrated in the figure, and may omit the input-output interface 313 as needed. In addition, the number of components such as the processor 311 included in the NFT management server 40 is not intended to be limited to the example shown in FIG. 35, and, for example, a plurality of processors 311 may be included in the NFT management server 40.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like for performing communication with other apparatuses. For example, the communication interface 314 includes a NIC (Network Interface Card) or the like.

The functions of the NFT management server 40 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the service server 10, the integrated management server 20, the content management server 30, the wallet server 50, and the metaverse server 60, and the like can also be configured by an information processing apparatus similarly to the NFT management server 40, and the basic hardware configuration thereof is not different from that of the NFT management server 40, so the description will be omitted.

The metaverse server 60, which is an information processing apparatus, is equipped with a computer, and the functions of the metaverse server 60 can be realized by causing the computer to execute a program. In addition, the metaverse server 60 executes a control method of the metaverse server 60 by using the program. Similarly, the NFT management server 40 is equipped with a computer, and the functions of the NFT management server 40 can be realized by executing a program on the computer. In addition, the NFT management server 40 executes a control method of the NFT management server 40 by using the program.

### Variations

The configurations, operations, and so on of the information processing system according to the above example embodiments are examples and do not limit the present system configuration, and so on.

In the above example embodiment, the configuration and the operation of the information processing system have been described taking, as an example, a case where NFT-ized content is used in the metaverse space. However, the digital content used in the metaverse space may not be NFT-ized. If the user has the authority to use the product in the metaverse space, the metaverse server 60 may use digital content (a 3D model) corresponding to the product in the metaverse space. In this case, the metaverse server 60 may acquire a product purchase certificate from the wallet of the user and request a content management server 30 to provide digital content corresponding to a product code described in the product purchase certificate. For example, with respect to a product such as a CD or a DVD, appearance information or genre information of the CD or the like may be provided free of charge to the metaverse server 60 as part of a service by an IP holder of the product. At that time, audio data or video data of a CD, a DVD, or the like may be provided free of charge, or may be provided for a fee.

In the above example embodiment, it has been described that the user logs into an EC site or a game server via the integrated management server 20. However, the user may log into the EC site or the like directly.

In the above example embodiment, a case has been described in which the integrated management server 20 issues a product purchase certificate. However, the EC site or the game server where the user purchased the product may issue the product purchase certificate.

In the above example embodiment, in a case where the user wishes to purchase NFT content, the NFT management server 40 has been described in connection with a case of verifying a product purchase certificate corresponding to the product selected by the user. However, the NFT management server 40 may perform verification in advance for each of a plurality of product purchase certificates owned by the user, and display a list of products for which the user can purchase NFT content. That is, the NFT management server 40 may exclude NFT content that the user cannot purchase and allow the user to select the NFT content (select the NFT content to purchase) using a GUI similar to FIG. 13.

In the above example embodiment, a case has been described in which the NFT management server 40 stores main data (actual data) and accompanying information of the NFT content. However, the main data and the like of the NFT content may be stored in the content management server 30 of the IP holder or may be stored in the integrated management server 20. Alternatively, the main data and the like of the NFT content may be stored in a blockchain. Alternatively, accompanying information of the NFT content may be described in metadata of the NFT.

The integrated management server 20 may manage an issuance status of the product purchase certificate (a purchase status of NFT content) in an account of each user. By managing the issuance status of the product purchase certificate of the user, the integrated management server 20 may display, in the GUI shown in FIG. 10, a product for which the certificate has not been issued and a product for which the certificate has been issued in a manner that the user can distinguish between them. For example, the integrated management server 20 may display “Certificate Issued” near a product (product name) for which the product purchase certificate has been issued. Alternatively, the integrated management server 20 may display the title of a product for which the product purchase certificate has not been issued in bold.

The integrated management server 20 may perform authentication of the user before issuing the product purchase certificate. For example, the integrated management server 20 may display a GUI such as that shown in FIG. 10 on a terminal 70 in a case where biometric authentication of a user who wishes to issue a product purchase certificate has succeeded. In this case, the integrated management server 20 acquires biometric information (for example, a face image) of the user (account holder) in a case where the account of the user is generated. In a case where the user (the user who has logged into the account) wishes to issue a product purchase certificate, the integrated management server 20 acquires biometric information of the user via the terminal 70. For example, the integrated management server 20 instructs the user to take a self-portrait using the terminal 70. The terminal 70 transmits the acquired biometric information to the integrated management server 20. The integrated management server 20 determines that the authentication of the user who wishes to issue a product purchase certificate has succeeded in a case where the biometric information stored in the account and the biometric information acquired from the terminal 70 substantially match. If the authentication of the user who wishes to issue a product purchase certificate has succeeded, the integrated management server 20 displays the GUI shown in FIG. 10 on the terminal 70.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system that sells digital content corresponding to a product purchased by a user or the like.

A part or the entirety of the example embodiments described above may be described as in the following supplementary notes, but is not limited to the followings.

### Supplementary Note 1

An NFT management apparatus including:
an acquisition means that acquires an NFT (Non-Fungible Token) issued by a fact that a user has purchased a product; and
a display control means that displays information related to the acquired NFT.

### Supplementary Note 2

The NFT management apparatus according to supplementary note 1, wherein the display control means displays the fact related to purchase of the product as part of a transaction history of the NFT so that the fact related to purchase can be distinguished from a history of issuance of the NFT.

### Supplementary Note 3

The NFT management apparatus according to supplementary note 1, wherein the display control means displays, in a case where the user is an authenticated user approved by an NFT platformer, a fact that the user is the authenticated user in a transaction history of the NFT.

### Supplementary Note 4

The NFT management apparatus according to supplementary note 1, wherein the display control means displays a title given to the user in accordance with a total quantity or a total amount of the NFTs transacted by the user.

### Supplementary Note 5

The NFT management apparatus according to supplementary note 1, wherein the display control means displays a transaction history of the NFT before and after a cross-chain bridge in a distinguishable manner.

### Supplementary Note 6

The NFT management apparatus according to supplementary note 1, wherein comments made by users of a metaverse space with respect to the NFT that is placed in the metaverse space are set for the NFT, and
wherein the display control means displays the comments on the NFT separately from a transaction history related to the NFT.

### Supplementary Note 7

The NFT management apparatus according to supplementary note 1, wherein the display control means displays a tag set for the NFT.

### Supplementary Note 8

The NFT management apparatus according to supplementary note 1, wherein the display control means displays, in a pseudo showcase, digital content corresponding to the purchased product of the user.

### Supplementary Note 9

A control method of an NFT management apparatus, the control method including:
acquiring an NFT (Non-Fungible Token) issued by a fact that a user has purchased a product; and
displaying information related to the acquired NFT.

### Supplementary Note 10

A program causing a computer mounted on an NFT management apparatus to perform processing for:
acquiring an NFT (Non-Fungible Token) issued by a fact that a user has purchased a product; and
displaying information related to the acquired NFT.

In addition, a part or all of the configurations described in supplementary notes 2 to 8, which are dependent on supplementary note 1 as described above, may also be dependent on supplementary notes 9 and 10 in the same dependent relationship as supplementary notes 2 to 8. Furthermore, not limited to supplementary note 1 and supplementary notes 9 and 10, within a range not departing from the above-described example embodiments, a part or all of the configurations described as supplementary notes can likewise be made dependent on various hardware, software, various recording means for recording the software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An NFT management apparatus comprising:
at least one memory storing a set of instructions; and
at least one processor configured to execute the set of instructions to:
acquire an NFT (Non-Fungible Token) issued by a fact that a user has purchased a product; and
display information related to the acquired NFT.

2. The NFT management apparatus according to claim 1, wherein
the at least one processor is further configured to execute the set of instructions to display the fact related to purchase of the product as part of a transaction history of the NFT so that the fact related to purchase can be distinguished from a history of issuance of the NFT.

3. The NFT management apparatus according to claim 1, wherein
the at least one processor is further configured to execute the set of instructions to display, in a case where the user is an authenticated user approved by an NFT platformer, a fact that the user is the authenticated user in a transaction history of the NFT.

4. The NFT management apparatus according to claim 1, wherein
the at least one processor is further configured to execute the set of instructions to display a title given to the user in accordance with a total quantity or a total amount of the NFTs transacted by the user.

5. The NFT management apparatus according to claim 1, wherein
the at least one processor is further configured to execute the set of instructions to display a transaction history of the NFT before and after a cross-chain bridge in a distinguishable manner.

6. The NFT management apparatus according to claim 1, wherein comments made by users of a metaverse space with respect to the NFT that is placed in the metaverse space are set for the NFT, and
wherein
the at least one processor is further configured to execute the set of instructions to display the comments on the NFT separately from a transaction history related to the NFT.

7. The NFT management apparatus according to claim 1, wherein
the at least one processor is further configured to execute the set of instructions to display a tag set for the NFT.

8. The NFT management apparatus according to claim 1, wherein
the at least one processor is further configured to execute the set of instructions to display, in a pseudo showcase, digital content corresponding to the purchased product of the user.

9. A control method of an NFT management apparatus, the control method comprising:
acquiring an NFT (Non-Fungible Token) issued by a fact that a user has purchased a product; and
displaying information related to the acquired NFT.

10. The control method of the NFT management apparatus according to claim 9, wherein the control method further comprises:
displaying the fact related to purchase of the product as part of a transaction history of the NFT so that the fact related to purchase can be distinguished from a history of issuance of the NFT.

11. The control method of the NFT management apparatus according to claim 9, wherein the control method further comprises:
displaying, in a case where the user is an authenticated user approved by an NFT platformer, a fact that the user is the authenticated user in a transaction history of the NFT.

12. The control method of the NFT management apparatus according to claim 9, wherein the control method further comprises:
displaying a title given to the user in accordance with a total quantity or a total amount of the NFTs transacted by the user.

13. The control method of the NFT management apparatus according to claim 9, wherein the control method further comprises:
displaying a transaction history of the NFT before and after a cross-chain bridge in a distinguishable manner.

14. A program causing a computer mounted on an NFT management apparatus to perform processing for:
acquiring an NFT (Non-Fungible Token) issued by a fact that a user has purchased a product; and
displaying information related to the acquired NFT.
